(19) United States
(12) Patent Application Publication
(10) Pub. No.: US 2019/0108486 A1
(43) Pub. Date: Apr. 11, 2019

(54) SYSTEM AND METHOD FOR INTELLIGENT AND AUTOMATIC ELECTRONIC COMMUNICATION SUPPORT AND ROUTING

(71) Applicant: Microsoft Technology Licensing, LLC, Redmond, WA (US)

(72) Inventors: Navendu Jain, Seattle, WA (US); Shane Hu, Seattle, WA (US)

(21) Appl. No.: 15/725,983

(22) Filed: Oct. 5, 2017

(51) Int. Cl. G06Q 10/10; H04L 29/06

(52) U.S. Cl. CPC G06Q 10/107; H04L 51/02; H04L 63/1433; G06Q 10/101

(57) ABSTRACT

Methods for automatic and intelligent electronic communication support, including using machine learning, are performed by systems and apparatuses. The methods intelligently and automatically route electronic communication support requests and intelligently and automatically provide senders with information related to their support requests. The methods generate feature vectors from cleaned request information via featurization techniques, and utilize machine-learning algorithms/models and algorithm/model outputs based on the input feature vectors. Based on the algorithm/model outputs and personalized to the specific sender, relevant support information is automatically provided to the sender. The methods also determine a set of prior communications related to the support request based on a similarity measure, and provide prior communication information to the sender. The methods also include routing support requests to correct feature owner recipients based on the algorithm/model outputs.

### BACKGROUND

Customer support is critical in operating customer-facing services. Electronic communications such as electronic mail (“email”) is a prevalent and easily accessible channel to provide such support. However, as electronic communication volume increases for support requests, the increased support workload hinders support team productivity. The TTE (e.g., Time-to-Engage) and TTR (e.g., Time-to-Resolve) for support requests also inevitability increases, ultimately decreasing customer satisfaction. In some cases, a mis-routing for electronic communication support requests further delays the TTE and TTR, as well as further decreasing productivity.

### SUMMARY

This Brief Summary is provided to introduce a selection of concepts in a simplified form that are further described below in the Detailed Description. This Brief Summary is not intended to identify key features or essential features of the claimed subject matter, nor is it intended to be used to limit the scope of the claimed subject matter.

Methods for automatic and intelligent electronic communication support, including using machine learning, are performed by systems and apparatuses. The methods intelligently and automatically route electronic communication support requests and intelligently and automatically provide senders with information related to their support requests. The methods generate feature vectors from cleaned request information via featurization techniques, and utilize machine-learning algorithms/models and algorithm/model outputs based on the input feature vectors. Based on the algorithm/model outputs and personalized to the specific sender, relevant support information is automatically provided to the sender. The methods also determine a set of prior communications related to the support request based on a similarity measure, and provide prior communication information to the sender. The methods also include routing support requests to correct feature owner recipients based on the algorithm/model outputs.

In one example, a system is provided. The system may be configured and enabled in various ways to perform automatic and intelligent electronic communication support, as described herein. The system includes at least one memory configured to store program logic for automated communication servicing, and also includes a processor(s) configured to access the memory and to execute the program logic. In the system, the program logic includes featurization logic, selector logic, and transmitter logic. The featurization logic is configured to apply featurization to first information according to at least one featurization operation to generate a feature vector, the first information being received in a first electronic communication from a sender, the first electronic communication comprising a request. The selector logic is configured to provide the feature vector as an input to a machine-learning model that automatically determines a model output based on the feature vector, and based at least in part on the model output, automatically select one or more of second information from a plurality of support information or a recipient from a plurality of possible recipients. The transmitter logic is configured to provide a second electronic communication that includes the second information to one or more of the sender or the recipient, or to provide the first electronic communication to the recipient.

In another example, a system is provided. The system may be configured and enabled in various ways to perform automatic and intelligent electronic communication support, as described herein. The system includes at least one memory configured to store program logic for automated communication servicing, and also includes a processor(s) configured to access the memory and to execute the program logic. In the system, the program logic includes featurization logic, locator logic, and transmitter logic. The featurization logic is configured to apply featurization to first information according to at least one featurization operation to generate a feature vector, the first information being received in a first electronic communication from a sender, the first electronic communication comprising a request. The locator logic is configured to automatically determine a set of prior communications related to the request based on a measure of similarity between the feature vector and feature vectors associated with the set of prior communications, and automatically select second information associated with the request from the set of prior communications. The transmitter logic is configured to provide the second electronic communication to the sender.

In still another example, a method performed in a computing system is provided. The method may be performed for automatic and intelligent electronic message support, as described herein. In embodiments, the method includes receiving a first electronic communication comprising a request from a sender, and performing at least one featurization operation for first information associated with the first electronic communication to generate a feature vector. The method also includes providing the feature vector as an input to a machine-learning model that automatically determines a model output based on the feature vector, and based at least on the model output, automatically selecting one or more of second information from a plurality of support information or a recipient from a plurality of possible recipients. The method further includes generating a second electronic communication that includes the second information and providing the second electronic communication to at least one of the sender or the recipient; and/or providing the first electronic communication to the recipient.

These and other objects, advantages and features will become readily apparent in view of the following detailed description of examples of the invention. Note that the Brief Summary and Abstract sections may set forth one or more, but not all examples contemplated by the inventor(s). Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate examples of the present application and, together with the description, further explain the principles of the example embodiments and to enable a person skilled in the pertinent art to make and use the example embodiments.

FIG. 1 shows a block diagram of a networked system for intelligent and automatic electronic communication support, according to an example embodiment.

FIG. 2 shows a block diagram of a computing system for intelligent and automatic electronic communication support, according to an example embodiment.

FIG. 3 shows a flowchart for intelligent and automatic electronic communication support, according to an example embodiment.

FIG. 4 shows a block diagram of a system for intelligent and automatic electronic communication support, according to an example embodiment.

FIG. 5 shows a flowchart for intelligent and automatic electronic communication support, according to an example embodiment.

FIG. 6 shows a flow diagram for intelligent and automatic electronic communication support, according to an example embodiment.

FIG. 7 shows a flowchart for intelligent and automatic electronic communication support, according to an example embodiment.

FIG. 8 shows a block diagram of a networked system for intelligent and automatic electronic communication support, according to an example embodiment.

FIG. 9 shows a block diagram of an example mobile device that may be used to implement various example embodiments.

FIG. 10 shows a block diagram of an example processor-based computer system that may be used to implement various example embodiments.

FIG. 11 shows a diagram of an interface for intelligent and automatic electronic communication support, according to an example embodiment.

The features and advantages of the examples described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an example embodiment,” “an example,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Section II below describes example embodiments for intelligent and automatic handling of electronic communication requests and modeling. In particular, Subsection II.A describes example intelligent/automatic routing and response embodiments, and Subsection II.B describes example modeling embodiments.

Section III below describes an example mobile device that may be used to implement features of the example described herein.

Section IV below describes an example processor-based computer system that may be used to implement features of the example described herein.

Section V below describes some additional examples and advantages.

Section VI provides some concluding remarks.

### II. Example Embodiments

The example techniques and embodiments described herein are provided for illustrative purposes, and are not limiting. The embodiments described herein may be adapted to any type of electronic and/or processing device, as well as systems thereof. Further structural and operational embodiments, including modifications/alterations, will become apparent to persons skilled in the relevant art(s) from the teachings herein.

The techniques and embodiments described herein provide for intelligently and automatically supporting electronic communication requests (also “requests” or “support requests” herein), such as but not limited to, electronically mailed (“emailed”) support requests, technical support requests, postings on messaging threads or forums such as those hosted by websites, social media postings, instant messages, conversations with automated mechanisms such as “bots,” billing, feedback, notifications, etc., that include requests such as for support, information, user access, and/or the like. That is, while embodiments herein may be described in the context of “support requests” as illustrative examples, such embodiments are also contemplated for other types of “requests,” such as but without limitation, the types noted above. In embodiments, requests may be intelligently and automatically routed to correct feature owners (i.e., recipients) of support teams, and intelligently generated automatic responses to requests may be provided to senders of support requests. Responses to requests may include information related to previous resolutions of prior support requests, as well as the prior support requests themselves. Relevant information in the responses may be highlighted or denoted for the sender's attention in different ways. Hosts and providers of systems and services that are utilized and/or accessed by users, customers, engineers, and/or the like (“users” herein) may employ support staff such as support engineers or other specialists either directly or indirectly via third parties to handle support requests. These support requests may be provided by such users or by automated mechanisms such as “bots.” As referred to herein, a “sender” may be any type of user or automated mechanism for providing support requests and/or information related thereto. Often times, the systems and services may receive large numbers, e.g., hundreds, thousands, or tens of thousands, of support requests from senders. When senders are not able to determine a specific owner/recipient for their support request, e.g., emails may be addressed to a single support email account for all services/products rather than a specific team or may be addressed to an entire support team instead of a specific feature owner(s) within the team, mis-routing or slow routing of support requests can occur which increases TTE (e.g., Time-to-Engage) and TTR (e.g., Time-to-Resolve) and can negatively impact the user. When the correct owner (e.g., a recipient) for a request does not receive notice of the request quickly, the TTE increases—that is, the time-to-engage the request after its submission and begin resolution by the correct support group is negatively impacted by mis-routings of request to incorrect recipients such as owners/support groups. Likewise, if a support group that is not the correct owner receives a request and begins work for resolution thereof, this group may not provide a correct solution/resolution for the request or may spend time on the request before realizing the request should be re-routed to a different, correct owner, again impacting the TTE. This in turn also increases the TTR for requests, i.e., resolving requests may be directly impacted by mis-routings. In embodiments, the TTR may be considered as the time from the submission of a request to the resolution of the request. That is, each support request may be varied in scope and content, such that a specific owner belonging to one or more support teams that supports a feature or service in the request, or a specific support team, should be tasked with overseeing the resolution of the request. To this end, the described embodiments and techniques herein provide for intelligent and automatic routing of support requests. Additionally, intelligent and automatic replies to support requests based on support request content may decrease TTE and TTR, and embodiments and techniques herein also provide for such features.

For example, a user of a system or a service, e.g., a cloud-based service, may have a problem with the behavior, features, operations, and/or the like, e.g., user access, of the system/service, and this problem may impact the productivity or business functions of the user. The user may provide a technical support request communication to the host and/or provider of the system or service. The host and/or provider of the system or service may desire to return the user to normal operations and productivity levels as soon as possible to avoid negative impacts to users and/or their businesses. However, the nature of the support request requires that the correct owner of the problem, feature, issue, etc., receive the support request and its information (i.e., be predicted as the recipient) for resolution, and as noted above, there may be hundreds or thousands of possible recipients for support requests. Similarly, routing for bug reporting, another type of “support request,” as well as feedback routing related to resolutions of support requests, include similar considerations for determining the correct recipient.

It should be noted that while embodiments herein are directed to various types of support requests, these embodiments are described in the context of automatic and intelligent support request handling for purposes of discussion and illustration. The described context is not to be considered limiting of any embodiments or equivalents herein.

The embodiments described herein provide for several techniques for properly and automatically routing support requests, and responding to support requests with technical support information, in an intelligent manner. Such techniques allow for scaling to large numbers of services, handling unstructured user inputs, and making accurate routing decisions based on limited information. For instance, to scale to large numbers of services, a communication support system may be configured to provide tracking workflows for hundreds to thousands of services where each service in turn may have several associated support teams or groups. In embodiments, for users or automated mechanisms creating and providing support requests via communication clients, the communication support system is configured to overcome difficulties in providing support requests to correct owners/recipients for support of features/products/systems/services. Because there may not be enough support request information available to manually identify the correct issue owner/team by the sender (e.g., a user notes specific system or service performance feature problems, but the underlying root cause could have been a problem in network, storage, other broad sets of services, etc.), the described techniques and embodiments provide an architecture configured to automatically accomplish such a task based on machine-learning algorithms that consume feature vectors for provided information.

The described embodiments and techniques may perform intelligent and automatic supporting electronic communication requests based on structure that is applied for unstructured inputs provided from users/senders in support requests. That is, unstructured, free form text inputs provided by a user for the request information/data (e.g., title, detailed description, error messages, logs, images, attachments, and/or the like), requires significant time to be consumed to manually read the large volume of text, particularly when support engineers do not have sufficient insights into all possible services/teams to which the support request should be assigned. The embodiments herein provide for communication support systems configured to featurize unstructured text, thus providing structure, for the application of the machine-learning algorithms described.

The described embodiments and techniques also provide intelligent and automatic support for electronic communication requests based on limited information received from users/senders in support requests. That is, accurate routing decisions for support requests are provided according to embodiments, despite a user/sender providing little information regarding the support request. For instance, in addition to providing an urgency tag for a given support request, the embodiments herein are configured to provide ‘actionable,’ fine-granularity information of what specific feature/product/system/service area needs attention for support requests, and, correspondingly, what service/team/engineer should be selected to receive the support requests.

### A. Example Embodiments for Intelligent, Automatic Request Handling

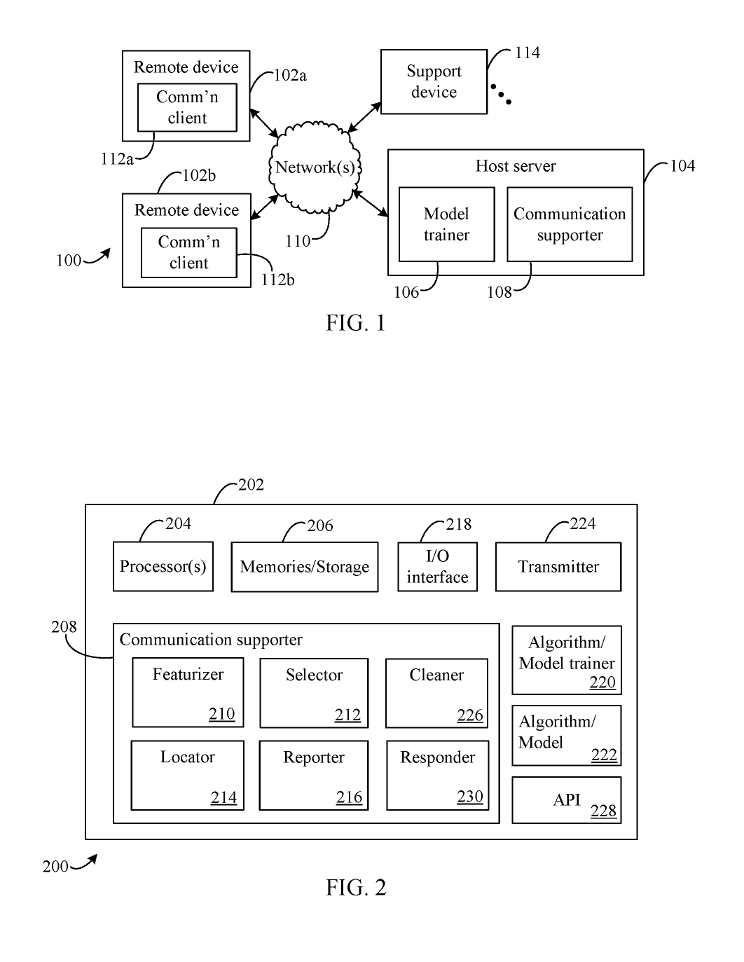

Accordingly, systems, apparatuses, and devices may be configured and enabled in various ways for intelligent and automatic handling of support requests. For example, FIG. 1 is a block diagram of a system 100, according to embodiments. System 100 is a computing system for intelligent and automatic handling of support requests, according to an embodiment. As shown in FIG. 1, system 100 includes a remote device 102a, a remote device 102b, a support device 114, and a host server 104, which may communicate with each other over a network 110. It should be noted that the number of remote devices and host servers of FIG. 1 is exemplary in nature, and greater numbers of each may be present in various embodiments. Additionally, any combination of components illustrated may comprise a system for intelligent and automatic handling of support requests, according to embodiments.

Remote device 102a, remote device 102b, support device 114, and host server 104 are configured to be communicatively coupled via network 110. Network 110 may comprise any type of connection(s) that connects computing devices and servers such as, but not limited to, the Internet, wired or wireless networks and portions thereof, point-to-point connections, local area networks, enterprise networks, and/or the like.

Host server 104 may comprise one or more server computers, which may include one or more distributed or “cloud-based” servers. Host server 104 is configured to receive support requests provided by senders, e.g., via a communication client 112a and/or communication client 112b, respectively from remote device 102a and/or remote device 102b via network 110. As illustrated, host server 104 includes a model trainer 106 and a communication supporter 108. In embodiments, host server 104 is configured to provide an interface for communication clients, such as communication client 112a and/or communication client 112b, to remote device 102a and/or remote device 102b via network 110. Host server 104 is also configured to train one or more machine-learning algorithms according to model trainer 106, in embodiments. Such machine-learning algorithms may be utilized to determine specific support groups/personnel as owners of support requests provided by senders via communication client 112a and/or communication client 112b. In embodiments, host server 104 is configured to utilize the machine-learning algorithm with communication supporter 108, described in further detail below, to intelligently and automatically route the support requests to the correct support owner(s), and/or to intelligently and automatically generate and provide responses to support requests that include technical support information for resolution of the support requests.

Remote device 102a and remote device 102b may be any type of computing device or computing system, including a terminal, a personal computer, a laptop computer, a tablet device, a smart phone, etc., that may be used to provide support requests, e.g., via communication client 112a and/or communication client 112b, in which a sender includes support request information. For instance, as shown in FIG. 1, remote device 102a includes communication client 112a, and remote device 102b includes communication client 112b. In embodiments, remote device 102a and remote device 102b are configured to respectively activate communication client 112a and/or communication client 112b to enable a user to provide information in a support request that is used to perform intelligent and automatic handling thereof. In some embodiments, remote device 102a and remote device 102b are configured to respectively receive interfaces such as GUIs from host server 104 to enable a user to provide information in a support request that is used to perform intelligent and automatic handling thereof. That is, communication client 112a and/or communication client 112b may operate independently of host server 104. In embodiments, remote device 102a and/or remote device 102b may include a stored instance of a communication client, as described above, which may be received from host server 104. In embodiments, communication client 112a and/or communication client 112b may be any type of electronic communication client or electronic communication application, such as email clients, messaging applications, portals, and/or the like.

Support device 114 may be any type of computing device or computing system, including a terminal, a personal computer, a laptop computer, a tablet device, a smart phone, etc., that may be used by support groups/personnel, e.g., technical support staff, technicians, engineers, etc., to receive and/or handle support requests from senders. Support device 114 may be configured to resolve problems presented in support requests via input from senders, may be configured to communicate messages to remote device 102a and/or remote device 102b in response to support requests, and may be configured to provide feedback related to support requests from recipients to host server 104. While a single support device 114 is illustrated for brevity and clarity, it is contemplated herein that any number of support devices 114 for support teams/personnel may be present in various embodiments.

As noted above, communication supporter 108 is configured to perform intelligent and automatic electronic communication support, e.g., the handling of support requests. Such handling may include routing of support requests using machine-learning algorithms, e.g., according to a classification model/algorithm in some embodiments, although other types of models/algorithms are contemplated herein, and generating and providing responses to support requests that include technical support information for resolution of the support requests. Support requests may include information input by a user via a communication client, as described herein, that describes a problem experienced with, inquiry for, etc., a service or system a user accesses. As noted above, a user may not know the root cause of a problem that the user is experiencing with a specific service or system, and/or which owner/support group should be responsible for handling the technical support request for the user (as a support request senders). As a non-limiting example embodiment, communication supporter 108 may be configured to determine a recipient(s) using, e.g., featurization techniques for the support request information from the user and a machine learning classifier with a machine-learning algorithm to consume featurized information and determine the correct recipient(s) for the support request.

Model trainer 106 is configured to train models, such as but not limited to, machine-learning algorithms like classification models/algorithms, to be used for performing automatic and intelligent electronic communication support. In embodiments, model trainer 106 is configured to train machine-learning algorithms offline for deployment, according to one or more featurization operations used by communication supporter 108 for structuring input data. Model trainer 106 is configured to train models using machine learning techniques and instance weighting, in an embodiment, and as discussed in further detail below.

Accordingly, remote device 102a, remote device 102b, support device 114, and/or host server 104 are configured to utilize one or more aspects of communication support systems for automatic and intelligent electronic communication support. Remote device 102a, remote device 102b, support device 114, and host server 104 may be configured and enabled in various ways to perform these functions.

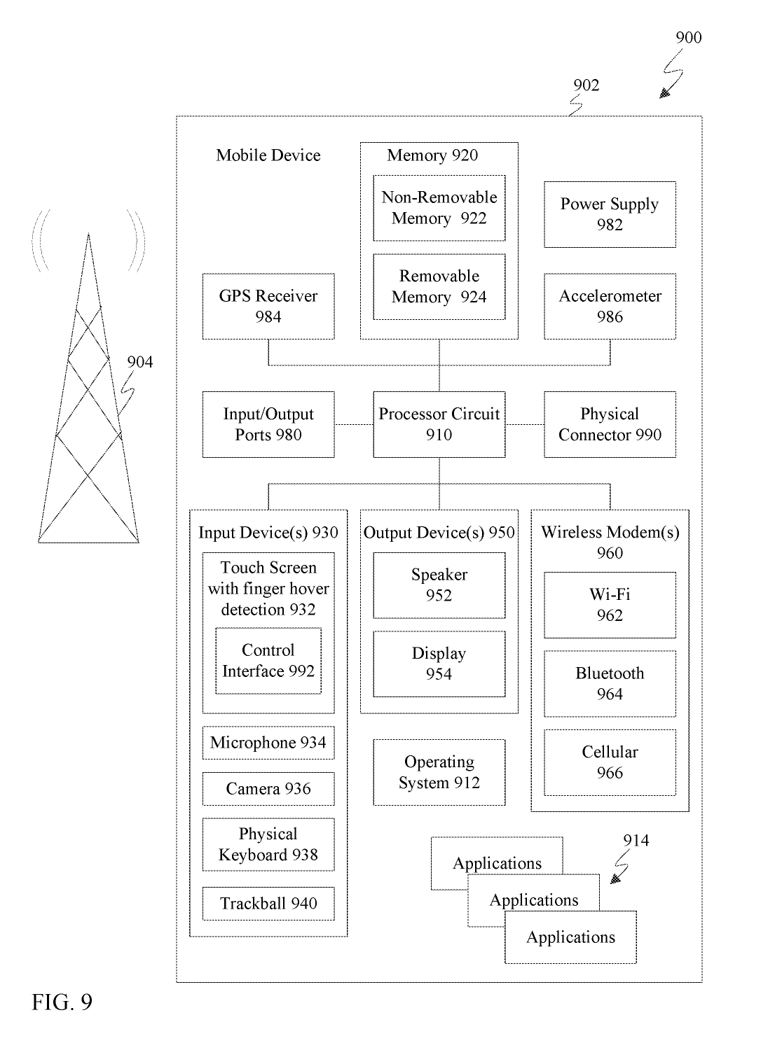

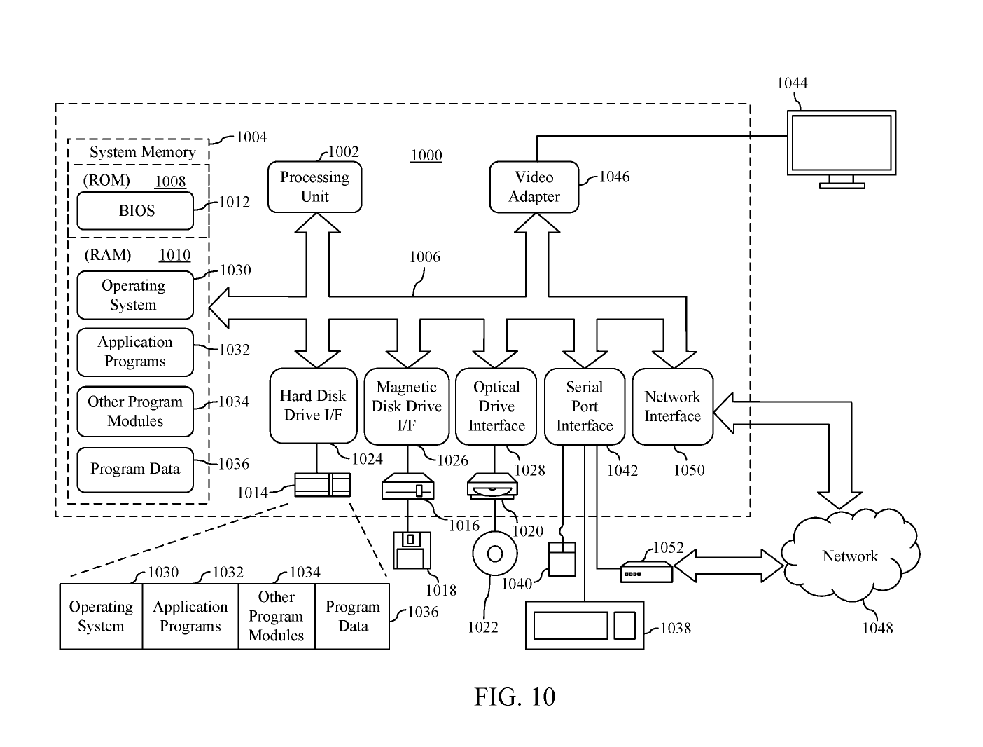

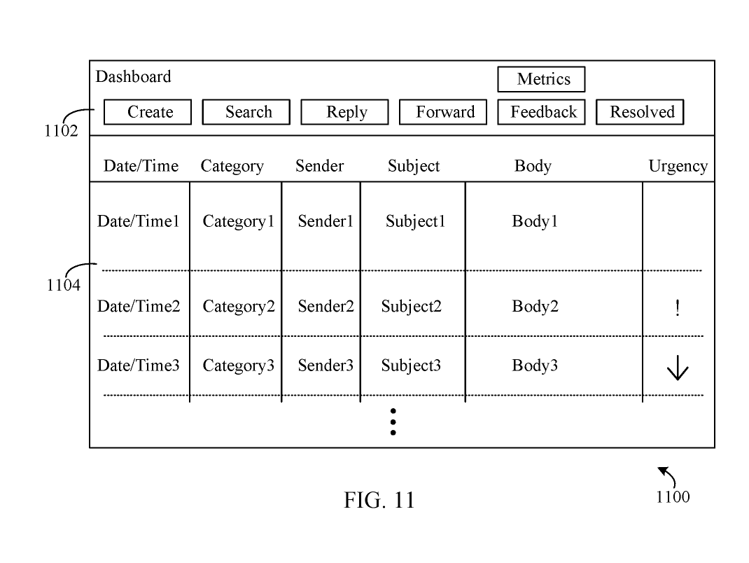

For instance, FIG. 2 is a block diagram of a system 200, according to an embodiment. System 200 may be a computing system for automatic and intelligent electronic communication support, in embodiments. As shown in FIG. 2, system 200 includes a computing device 202 which may be referred to as a computing system. System 200 may be a further embodiment of system 100 of FIG. 1, and computing device 202 may be a further embodiment of host server 104, remote device 102a, and/or remote device 102b of FIG. 1. Computing device 202 may be any type server computer or computing device, as mentioned elsewhere herein, or as otherwise known. As shown in FIG. 2, computing device 202 includes one or more of a processor (“processor”) 204, one or more of a memory and/or other physical storage device (“memory”) 206, an input/output (I/O) interface 218, and a communication supporter 208 which may be an embodiment of communication supporter 108 of FIG. 1. System 200 may also include a model trainer 220 (which may be an embodiment of model trainer 106 in FIG. 1), a model 222 (e.g., an algorithm or model, according to the described embodiments), a transmitter 224, and an application programming interface (API) component 228. System 200 may also include additional components (not shown for brevity and illustrative clarity) including, but not limited to, a communication client such as communication client 112a and/or communication client 112b, as well as those described below with respect to FIGS. 9 and 10, e.g., an operating system.

Processor 204 and memory 206 may respectively be any type of processor circuit or memory that is described herein, and/or as would be understood by a person of skill in the relevant art(s) having the benefit of this disclosure. Processor 204 and memory 206 may each respectively comprise one or more processors or memories, different types of processors or memories, remote processors or memories, and/or distributed processors or memories. Processor 204 is configured to execute computer program instructions such as but not limited to embodiments of communication supporter 208, e.g., as computer program instructions for automatic and intelligent electronic communication support, etc., as described herein, and memory 206 is configured to store such computer program instructions, as well as to store other information and data described in this disclosure, including but without limitation, model 222, past support requests and responses, technical support wiki-pages, frequently asked questions, information for personalization, etc.

I/O interface 218 may be any type of wired and/or wireless network adapter, modem, etc., configured to enable computing device 202 to communicate with other devices over a network, e.g., such as communications between host server 104, remote device 102a and/or remote device 102b over network 110 as described above with respect to FIG. 1.

Model trainer 220 is configured to machine-train models/algorithms, referred to generally herein as selectors, such as but not limited to, classification, regression, comparison-matching, clustering, word embeddings (e.g., for feature compression), feature selection, and/or the like, to be used for performing automatic and intelligent electronic communication support. The terms “model” and “algorithm” may be used interchangeably herein in the context of machine-learned models/algorithms. Several embodiments herein may be generally described in the context of classifiers and machine-learning algorithms for classification, however, such description is for purposes of illustration and description and is not to be considered limiting. Where an embodiment refers to a classifier, a machine-learning classifier, or a classification, an equivalent component and/or determination for other machine-learning algorithms noted herein, and their equivalents, is also contemplated.

Classification models/algorithms may be trained, offline in some embodiments, for deployment, according to one or more featurization operations used by communication supporter 208 for structuring input data, and model trainer 220 may be configured to train models using machine learning techniques and instance weighting, according to embodiments. In embodiments, classification models may be or may comprise algorithms, such as machine-learning algorithms, for automatically and intelligently determining recipients for routing electronic communication support requests. Further details concerning model training are provided below.

Model 222 may be trained by model trainer 220, according to embodiments. Model 222 may be a classification model utilized for classifying electronic communication support requests and/or the like, for proper routing to recipients (e.g., support groups/teams/engineers) for handling. Model 222 may be configured to take a feature vector for a support request as an input from featurizer 210, and provide a model output. Model 222 may generate this model output through a classification of the support request, based on the feature vector, into one or more predefined taxonomies determined during the training of model 222. In embodiments, model 222 may also take sender-specific information as an input to personalize the response to the sender. For example, prior model outputs for communications from the sender, the communications themselves, prior recipients determined for past communications from the sender, and/or the like, may be taken into account by model 222 to personalize model outputs accordingly, resulting in personalized responses to the sender. In some embodiments, users may have specific, personalized model instances of model 222 trained according to one or more sender-specific information inputs and/or user-specific aspects of model 222 may be weighted more as inputs. Personalization may be based on one or more of the follow illustrative examples, although additional bases for personalization may be used as would become apparent of one of skill in the relevant art(s) having the benefit of this disclosure.

For example, personalization may be based on prior responses sent to the sender/user. In embodiments, the recommended answers/information for a sender's/user's request may be first checked against previous responses sent to that sender/user for a current or prior request, e.g., to avoid sending duplicate or similar answers. As another example, personalization may be based on the effectiveness of answers. In embodiments, the recommended answers for a sender's/user's request may be first checked against similar questions asked by other users/senders and the effectiveness of their answers (e.g., some of those users/senders marked the answer as satisfactory as having solved their problem via feedback). The answers marked useful by other users/senders may be weighted up to compute the final ranking and/or listing of answers for a request of a user/sender. In still another example, personalization may be based on a sender's/user's team/service membership. In embodiments, the recommended answers for a sender's/user's request may be filtered based on the sender's/user's team(s), e.g., feature areas of what that team works on, the type(s) of requests from that team in the recent past, a dependency graph(s) of that team's services related to other teams, etc. As yet another example, personalization may be based on a sender's/user's preferences. For instance, in embodiments, a user may specify their preferences or configuration settings that may affect the type and ordering of recommended answers for their requests (e.g., in a web search like setting). In an example scenario, a user/sender may want to order the answers by up-votes or popularity across users/senders, while in other cases other users may want to prioritize the latest answer by date. In still other cases, some other users may want to filter by type of answers, e.g., remove ‘informational’ type of responses and instead prioritize the ones marked as ‘solutions’. It should be noted that these cases and scenarios are not mutually exclusive in embodiments. As still another example, personalization may be based on a sender's/user's attributes. In embodiments, a sender's/user's metadata, such as but without limitation, domain expertise, job type (e.g., developer versus service engineer), geographic location, ownership of specific components, etc., may also affect the set of results/answers and their rankings.

Model 222 may be trained, e.g., offline, using data/information from prior electronic communications and/or electronic communication support requests received, and/or using a priori information. For instance, a classification model may be trained on information associated with electronic communications provided by one or more users/senders for previously submitted support requests, feedback information for previously submitted support requests from senders and/or support teams, performance metrics, technical support information for resolutions, etc., as well as deduced information (e.g., when an incorrect recipient is predicted, it may be inferred that the recipient with the next highest likelihood for prediction is the correct recipient). In the context of information associated with support requests received from users/senders for training, model 222 may be trained with one or more featurization operations used by communication supporter 208 for structuring input data, e.g., as feature vectors (described in further detail below). In this way, the training for model 222 closely corresponds to feature vectors utilized by communication supporter 208 (e.g., utilizing a featurizer 210) for classification of electronic communication support requests.

Featurization operations for training of models, such as model 222, may include, without limitation, a K-means clustering featurization for grouping similar features, a keyword featurization for determining the presence of keywords, a content-based featurization (e.g., at least one electronic message attribute of a character count, a byte count, and/or a ratio of numeric to alphabetic characters), a context-based featurization, a semantic-based featurization (e.g., one or more triplet sets that each include an entity, and action, and a qualifier), an n-gram featurization, a skip-gram featurization, a bag of words featurization, a char-gram featurization, a feature selection featurization (including count-based feature selection to keep the most frequently used terms and remove less frequently used terms, and/or correlation-based feature selection to calculate the similarity of each feature to input labels and keep the most important features as calculated by the correlation), and/or the like.

For example, featurizer 210 of FIG. 2 may be configured to generate a feature vector for a received support request based on sender-supplied information provided therein. Featurizer 210 may be configured to perform one or more featurization operations such as, but not limited to, a K-means clustering featurization, a keyword featurization, a content-based featurization, a context-based featurization, a semantic-based featurization, an n-gram featurization, a skip-gram featurization, a bag of words featurization, a char-gram featurization, and/or a feature selection featurization. Feature vectors generated may comprise any number of feature values (i.e., dimensions) from tens, hundreds, thousands, etc., of feature values in the feature vector. As noted above, in embodiments, a featurization operation is an operation that transforms at least a portion of information, e.g., the unstructured text, into one or more representations that describe characteristics of a portion(s) of the information. As an illustrative example, featurizer 210 may take the support request information, or a portion thereof, as an input and perform a featurization operation to generate a representative output value(s)/term(s) associated with the type of featurization performed, where this output may be an element(s)/dimension(s) of the feature vector. Syntactic features may include one-hot (e.g., binary/boolean) encoding for keywords in the subject and body of support requests, a frequency-inverse document frequency (TF-IDF) matrix for subject and keywords, a ratio or percentage for numerical digits versus alphabet characters in the support request, the presence of an attachment(s), the request size (e.g., in bytes), a number of people/entities copied for the receipt of the support request, a number of people/entities for which the support request is directed addressed, and/or the like. Semantic features may include parts-of-speech tags, e.g., a bag of words transform, features of the SysSieve learning system from Microsoft Corporation of Redmond, Wash., entity-actions-qualifier trios at different abstraction levels extracted from the support request, and/or the like.

For instance, clustering may be based on a fixed “K” thread or may be based on dynamically determined “K” threads for processing based on cohesiveness of the data provided. Additionally, any number of keywords (or keyphrases: e.g., a contiguous multi-word sequence containing domain-specific important information) may be used by featurizer 210 in determining a keyword portion of the feature vector (e.g., any number of Boolean entries for pre-determined keywords either being present or not present in the information).

Context- and semantic-based featurization may also be performed by featurizer 210 to provide structure to unstructured information that is received. In embodiments, featurizer 210 may utilize the SysSieve learning system for semantic-based featurizations. For example, semantic-based feature sets may be extracted by featurizer 210 for technical phrases from the support request information provided by the information provider. Semantic-based features sets may comprise, without limitation, domain-specific information and terms such as global unique identifiers (GUIDs), universal resource locators (URLs), emails, error codes, customer/user identities, geography, times/timestamps, and/or the like. The use of semantic-based featurization for domain-specific features provides rich, discriminative sets of features that improve accuracy in service/recipient determinations.

Count-based featurization may also be performed by featurizer 210 to count alphanumeric characters present in a support request to determine a length or size of the request and the information provided therein, e.g., a size in bytes for the request, for the feature vector. Count-based featurization may also, or alternatively, include a ratio of digits-to-alphabetic characters for inclusion in the feature vector.

N-gram, skip-gram, and char-gram featurizations may also be implemented to determine numbers of word and/or character groups present in the information, and count- and/or correlation-based feature selection as featurization may also be performed by featurizer 210 for text associated with the information received in support requests to determine if system/service features are present and designate such system/service features in the feature vector. Featurizations may also utilize a bag of words transform.

A feature vector for a support request may be created using the above featurizations (e.g., featurization operations) by setting a bit(s) and/or a value in the feature vector for descriptive support request information and for results of the featurization steps described herein, e.g., if a key phrase/word is present in the support request information. In some embodiments, a feature vector may be determined based at least in part on technical support reference information, as described herein.

According to embodiments, model 222 may comprise one or more models or templates, as described herein, and may be stored by memory 206. Model 222 may be incrementally, or wholly, updated by model trainer 220 based on feedback, additional electronic communication support requests received, and/or the like.

Transmitter 224 is configured to provide or transmit electronic communications to senders and/or recipients, e.g., to senders via communication client 112a and/or communication client 112b of FIG. 1 and/or to recipients via support device 114 of FIG. 1. Electronic communications transmitted to senders may be response communications generated by communication supporter 208, as described herein, and may include information for resolving or mitigating a support request provided by the sender. Electronic communications transmitted to recipients may be electronic communication support requests from senders and/or may be the response communications generated by communication supporter 208, as described herein, and may include information for resolving or mitigating a support request provided by the sender. Further details for exemplary generation of response communications is provided below. Transmitter 224 may be configured to transmit response communications and/or forward electronic communication support requests using an API, as described below. In such embodiments, the API may be utilized by, and/or may be a part of, transmitter 224.

API component 228 may comprise one or more APIs configured to interface with machine-learning models/algorithms, communication components, databases/data stores, and/or the like, as described herein, for automatic and intelligent electronic communication support. For example, API component 220 may include an API that is configured to interface with an electronic communications component, such as an email or exchange server, and may include an API that is configured to interface databases/data stores that contain stored electronic communications, stored support information, etc. It should also be noted that API component 220 and/or APIs included therein may be invoked by any systems and components of systems herein, according to embodiments.

Communication supporter 208, as illustrated, includes a plurality of components for performing the techniques described herein for automatic and intelligent electronic communication support, including using machine learning, according to embodiments. As shown, communication supporter 208 includes a featurizer 210, a selector 212, a locator 214, a reporter 216, a cleaner 226, and a responder 230. While shown separately for illustrative clarity, in embodiments, one or more of featurizer 210, selector 212, locator 214, reporter 216, cleaner 226, and/or responder 230 may be included together with each other and/or as a part of other components of system 200. Additionally, as previously noted, while selector 212 may be referred to as a classifier and while selector 212 is exemplarily illustrated for clarity and brevity, this component may be substituted for, or other/additional machine-learning components may be additionally included for, a regression component, a clustering component, a comparison-matching component, etc. Likewise, selector logic may be an equivalent representation of a selector in embodiments, and other types of machine-learning algorithm logic, or machine-learning algorithm logic generally, are also contemplated for various embodiments.

Selector 212 may be configured to automatically determine a recipient for a received support request based on a feature vector for the received support request generated by and received from featurizer 210. Selector 212 is configured to process the feature vector according to an algorithm or model, such as model 222. According to embodiments, selector 212 may be a classifier such as a machine-learning classifier that utilizes machine learning techniques based on a learning model or classification model. In embodiments, a support request may be determined or classified with respect to a number of known classes for support based on features denoted in the feature vector. That is, depending on the classification, a specific recipient(s) may be determined based on the class or features indicated by the processing of a feature vector. Selector 212 may also be configured to automatically select/retrieve technical support information stored in a database based on a generated feature vector for the received support request from featurizer 210 and/or based on the prediction of the recipient according to model 222. Selector 212 may also be configured to determine an indication of urgency related to the information in a support request, where the indication may be provided to the recipient, based on the feature vector. For example, one or more features of the feature vector may correspond to features/systems/services or problems that are designated as having a higher than normal priority for technical support provision. In some embodiments, support requests may be classified according to urgency and provided to appropriate support groups.

Locator 214 may be configured to locate and retrieve one or more stored electronic communications related to support requests. Requests may be located and retrieved by locator 214 based on similarity in embodiments. For instance, a determination of similarity may be made between a received request and one or more stored requests based on how many features of feature vectors of the received request and the stored requests correspond to and/or highly correlate with each other. In embodiments, a higher correspondence/correlation for similarity of feature vectors may cause a stored request to be retrieved. In embodiments, locator 214 may be configured to utilize a nearest neighbor (kNN) model that is based on a cosine metric. For example, the kNN model configured to determine a previously-received electronic communication(s) associated with a previously-determined resolution related to a support request.

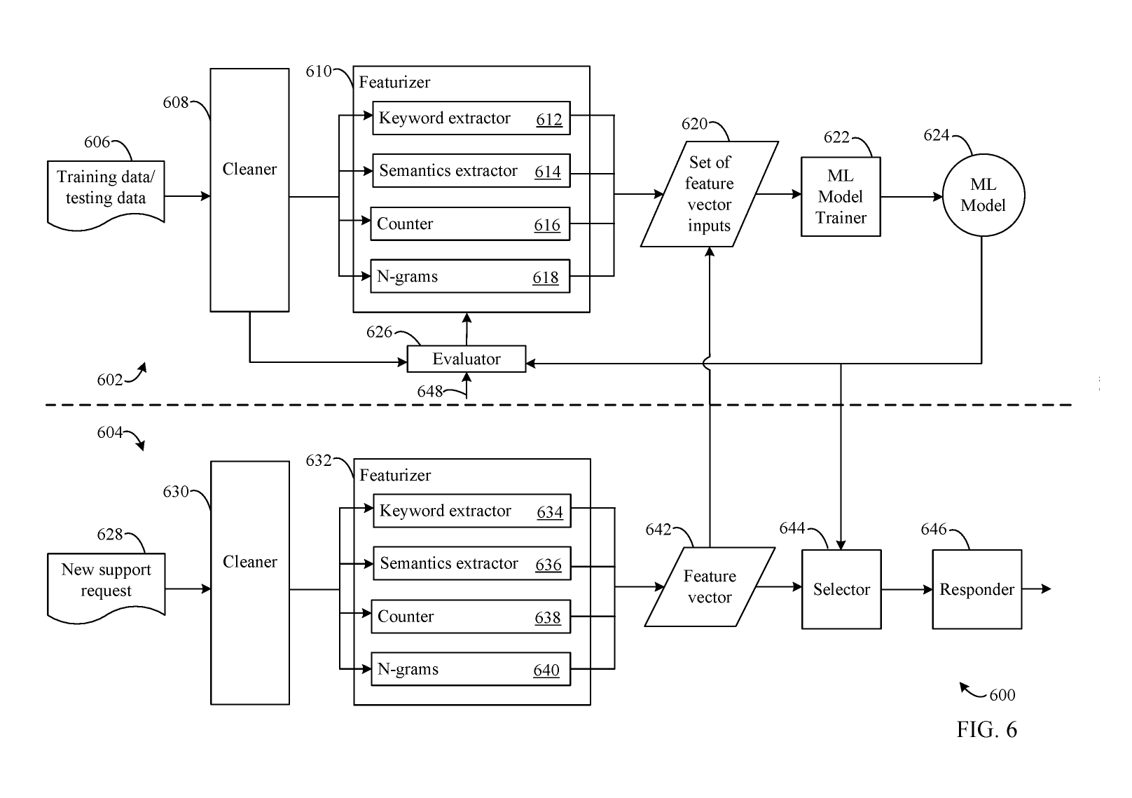

Reporter 216 may be configured to provide re-route indications of mis- and/or incomplete-routings for support requests to recipients and/or to model training components, such as model trainer 220, and/or as described in detail below (e.g., an evaluator as described in FIG. 6). Reporter 216 may also be configured to determine and provide metrics related to a support request to model trainer 220. Reporter-determined metrics for a support request may include TTE, TTR, a number of mis-routings, portions of sender and/or recipient feedback, support request information, and/or the like.

Cleaner 226 of FIG. 2 may be configured to perform cleaning operations for information received in electronic communication support requests, e.g., unstructured text. Cleaning operations may include one or more of character or word removal (including tags for markup and/or programming languages and long base64 strings, e.g., for image text), lemmatization, whitespace condensing, and/or, case normalization, and may be performed to provide initial structure to unstructured information, e.g., textual information, and to remove extraneous characters and/or redundancies from the information. In embodiments, cleaning operations may also be performed for structured text included with the information received in electronic communication support requests.

Responder 230 may be configured to automatically generate electronic messages that respond to received support requests and/or to provide received support requests to recipients. In embodiments, responder 230 may provide received support requests via transmitter 224 to recipients in support groups based on recipient predictions made by selector 212 (e.g., a machine-learning classifier). Responder 230 may also generate responses to support requests (as responsive electronic communications) that are provided to senders and/or recipients in support groups based on recipient predictions of selector 212, and provide the generated responses via transmitter 224. These generated responses may include automatically selected technical support information obtained by selector 212 and/or previously-received support requests (or communication threads/resolutions associated with the previously-received support requests) obtained by selector 212 via locator 214. In embodiments, the automatically selected technical support information may include one or more of a technical support reference portion with a step-by-step solution for the technical support request, a selectable link to a proposed resolution for the request, a representation of the previously-determined resolution related to the request, at least one previously-received electronic communication, and/or one or more previously-received and annotated electronic communications associated with the previously-determined resolution. In embodiments, answer/resolution strings may be annotated and/or highlighted.

Responder 230 may also be configured to solicit feedback from senders through generated responses to support requests. Solicitations may be made by text and/or selectable options that would indicate the feedback of the sender with respect to resolution and technical support information provided for a support request.

In some embodiments, an indication of urgency, as determined by selector 212, e.g., a flag in the message, text indicating the urgency, highlighting content, etc., may be included in responses generated by responder 230 that are provided to support group recipients. Further details regarding these and other components of communication supporter 208 are provided elsewhere herein, including as follows.

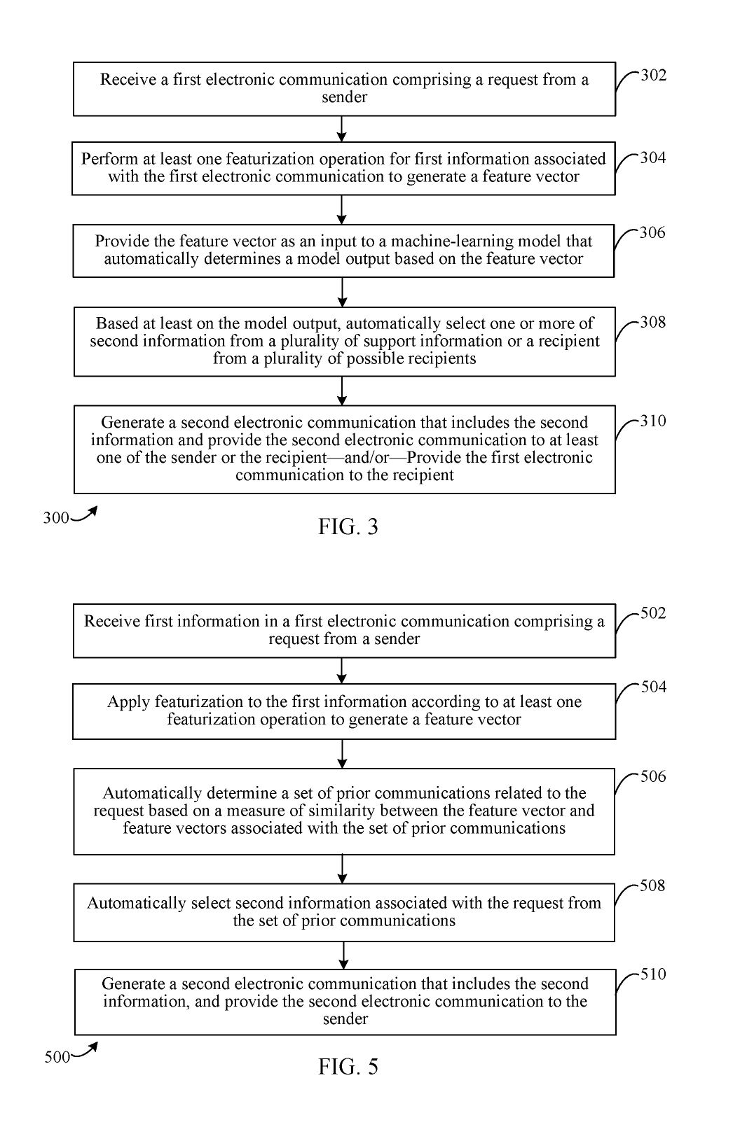

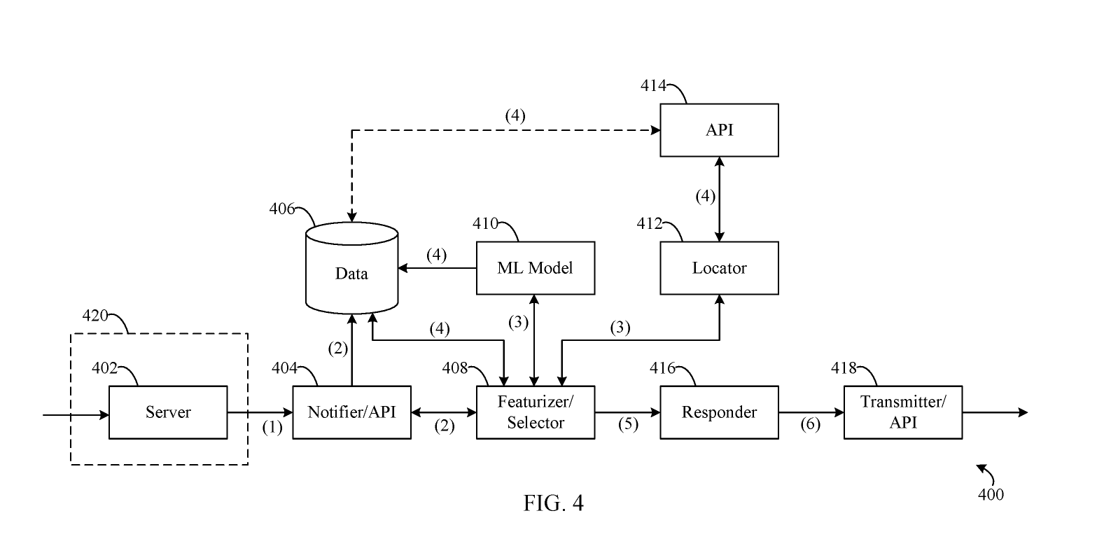

Referring also now to FIG. 3, a flowchart 300 for performing automatic and intelligent electronic communication support is shown, according to an example embodiment. In embodiments, flowchart 300 may perform these functions using machine learning, as described herein. For purposes of illustration, flowchart 300 of FIG. 3 is described with respect to system 200 of FIG. 2 and its subcomponents, and also with reference to FIG. 4 (described below). That is, system 200 of FIG. 2 may perform various functions and operations in accordance with flowchart 300 for automatic and intelligent electronic communication support. Further structural and operational examples will be apparent to persons skilled in the relevant art(s) based on the following description.

As noted, system 200 of FIG. 2 and flowchart 300 of FIG. 3 are described with reference to FIG. 4. In FIG. 4, a block diagram is shown of a system 400 according to an embodiment. System 400 may be a system for automatic and intelligent electronic communication support, in embodiments. System 400 may be a further embodiment of system 100 of FIG. 1 and/or of system 200 of FIG. 2. As shown in FIG. 4, system 400 includes a server 402. As further shown in FIG. 4, system 400 also includes a notifier 404, a database/data store 406 (“DB 406” herein), a featurizer/selector 408 which may be an embodiment of featurizer 210 and selector 212 of FIG. 2, a locator 412 which may be an embodiment of locator 214 of FIG. 2, an API 414 which may be an API of API component 228 of FIG. 2, a responder 416 which may be an embodiment of responder 230 of FIG. 2, and a transmitter 418 which may be an embodiment of transmitter 224 of FIG. 2. System 400 may also include a machine-learning (ML) model 410 (e.g., an algorithm or model, according to the described embodiments) which may be an embodiment of model 222 of FIG. 2. System 400 may also include additional components (not shown for brevity and illustrative clarity) including, but not limited to, other components described in systems and embodiments herein.

Server 402 may be a host server for electronic communications, such as an exchange server for email or an exchange web service such as those offered by Microsoft Corporation of Redmond, Wash., in embodiments. Server 402 may be a part of a separate system 420 that is communicatively coupled to the remaining components of system 400, in some embodiments. Server 402 may be any type server computer or computing device, as mentioned elsewhere herein, or as otherwise known.

Notifier 404 is configured to monitor electronic messages received at server 402, such as support request communications (e.g., emails). In embodiments, notifier 404 may include or utilize functionality of an API for an exchange web service, e.g., StreamingNotification offered by Microsoft Corporation of Redmond, Wash., to listen for and receive new support requests from server 402. When a new support request is received by server 402, notifier 404 is configured to store the received request in DB 406 for later use/reference, and to alert and provide the received support request to featurizer/selector 408. In embodiments, notifier 404 may be included as a component of system 200 of FIG. 2, e.g., as part of communication supporter 208.

DB 406, in additional to storing received support requests, may also be configured to store technical support information related to solving support requests, including but without limitation, frequently asked questions (FAQs) and/or links thereto, solutions and/or communications associated with prior support requests, recipients of prior support requests, possible recipients for received support requests, etc. While illustrated as a single component, DB 406 may comprise one or more portions for storing the data/information described herein. Additionally, one or more portions of DB 406 may be located locally or remotely with respect to system 400 and/or with respect to each other.

Featurizer/selector 408 may be configured to perform operations of any featurizer and/or selector described herein. For instance, featurizer/selector 408 may be configured to perform any operations of featurizer 210 of FIG. 2 and/or selector 212 of FIG. 2. Featurizer/selector 408 may be configured to access DB 406, in embodiments, to retrieve data/information stored therein based on information received in a support request. For instance, based on a generated feature vector and/or a prediction of ML model 410 (described below), featurizer/selector 408 is configured to automatically select/retrieve information from the technical support information or a recipient from a plurality of possible recipients, based on a prediction of ML model 410 (described below), stored in DB 406. Featurizer/selector 408 may also be configured to store generated feature vectors in DB 406.

ML model 410 may be a classifier or classification model, according to embodiments, or may be any other model/algorithm described herein in other embodiments, and may be configured to personalize outputs for specific senders as similarly described above with respect to model 222 of FIG. 2. As a non-limiting example embodiment, ML model 410 may be a classifier configured to determine a recipient(s) for a received support request using, e.g., featurization techniques for the support request information from the user/sender and a machine learning classifier with a machine-learning algorithm to consume the featurized information (e.g., a feature vector) and determine the correct recipient(s) for the support request. In determining recipients for support requests, ML model 410 may be configured to store recipient predictions, model outputs, and/or feature vector inputs in DB 406, as shown.

Locator 412 may be configured to locate and retrieve one or more stored electronic communications related to support requests, as similarly described above for locator 214 of FIG. 2. For example, locator 412 may receive a feature vector for a received support request from featurizer/selector 408 to determine stored electronic communications that are similar to the received support request. In embodiments, locator 412 may utilize, or include, API 414 for performing its functions and operations. API 414 may be a machine learning API associated with a cloud service, such as Azure® from Microsoft Corporation of Redmond, Wash. According to embodiments, locator 412 may compare the feature vector of a received support request to feature vectors of stored electronic communications/support requests to determine similarities thereof, and locate/retrieve the associated, stored electronic communications/support requests via API 414. API 414 may be configured to access DB 406, or other system databases/data stores, for the described locating/retrieving.

Responder 416 may be configured to perform the functions and operations of responder 230 of FIG. 2. For example, responder 416 may be configured to automatically generate electronic messages that respond to received support requests and/or to provide received support requests to recipients. In embodiments, responder 230 may provide received support requests via transmitter 418 to recipients in support groups based on recipient predictions of featurizer/selector 408 (e.g., a machine-learning classifier). Responder 416 may be configured to generate and provide responses to support requests (as responsive electronic communications) to senders and/or recipients in support groups based on recipient predictions of selector 212. These generated responses may include automatically selected technical support information obtained by featurizer/selector 408 from DB 406 and/or previously-received support requests (or communication threads associated with the previously-received support requests) obtained by featurizer/selector 408 via locator 412.

Transmitter 418 may be configured to perform the functions and operations of transmitter 224 of FIG. 2. For instance, transmitter 418 may be configured to provide or transmit electronic communications (e.g., received support requests and/or automatically generated responses from responder 416) to senders and/or recipients. Electronic communications transmitted by transmitter 416 may include information for resolving or mitigating a support request provided by the sender. Transmitter 224 may be configured to transmit response communications and/or forward electronic communication support requests using an API, e.g., as described with respect to notifier 404. In such embodiments, the API may be utilized by, and/or may be a part of, transmitter 418.

As illustrated in FIG. 4, an exemplary, numbered order of operations is provided, according to an embodiment. However, it should be noted that alternate orders of operation are also contemplated herein, e.g., parallel and/or serial orders, or any combination thereof) and the illustrated embodiment is not to be considered limiting.

Flowchart 300 of FIG. 3 is described as follows. Flowchart 300 begins at step 302. In step 302, a first electronic communication comprising a technical support request from a sender is received. For instance, as noted above, a sender may provide an electronic communication support request with information related to the technical support request via a communication client as described with respect to FIG. 1. The support request may be an email support request that is received by server 402 of FIG. 4. Notifier 404 is configured to monitor incoming support requests, save such support requests to DB 406, and also provide them to featurizer/selector 408. Information in the technical support request may be included in the subject line or the body of the electronic communication, and may comprise text describing the problem experienced by the sender, services or products related to the problem, images/screenshots, error messages/code, dates/times, solutions attempted by the sender, attachments, and/or the like.

In step 304, at least one featurization operation is performed for first information associated with the first electronic communication to generate a feature vector. For example, featurizer/selector 408 of FIG. 4 may be configured to generate a feature vector for a support request based on information provided and received in step 302. Featurizer/selector 408 may be configured to perform one or more featurization operations such as, but not limited to, a K-means clustering featurization, a keyword featurization, a content-based featurization, context-based featurization, a semantic-based featurization, an n-gram featurization, a skip-gram featurization, a bag of words featurization, a char-gram featurization, and/or a feature selection featurization for data, attachments, text, etc., included in the support request (including the subject and/or body of a support request message). Feature vectors generated may comprise any number of feature values (i.e., dimensions) from tens, hundreds, thousands, etc., of feature values in the feature vector.

For instance, clustering may be based on a fixed “K” thread or may be based on dynamically determined “K” threads for processing based on cohesiveness of the data provided. Additionally, any number of keywords may be used by featurizer/selector 408 in determining a keyword portion of the feature vector (e.g., any number of Boolean entries for pre-determined keywords either being present or not present in the information). Context- and semantic-based featurization may also be performed by featurizer/selector 408 to provide structure to unstructured information that is received. N-gram, skip-gram, and char-gram featurizations may also be implemented to determine numbers of word and/or character groups present in the information, and count- and/or correlation-based feature selection as featurization may also be performed by featurizer/selector 408 on text associated with the information received in step 302 to determine if system/service features are present and designate such system/service features in the feature vector.

In step 306, the feature vector is provided as an input to a machine-learning model that automatically determines a model output based on the feature vector. For example, ML model 410 may generate this model output through a classification of the support request, based on the feature vector, into one or more predefined taxonomies determined during the training of model 410. That is, support requests may be mapped to features/products/systems/services by way of ML model 410. In embodiments, featurizer/selector 408 of FIG. 4 may be configured to automatically determine a recipient(s) based on the feature vector generated in step 304. Featurizer/selector 408 may be configured to process the feature vector according to an algorithm or model to generate an output for predicting the correct recipient(s) for the support request. According to embodiments, featurizer/selector 408 may utilize ML model 410 in making the prediction. ML model 410 may be a classifier, in embodiments, such as a machine-learning classifier that utilizes machine learning techniques based on a learning model or classification model. ML model 410 is configured to provide its output (e.g., a correct recipient prediction) to featurizer/selector 408.

In step 308, one or more of second information from a plurality of technical support information or a recipient from a plurality of possible recipients is automatically selected based at least on the model output. For instance, featurizer/selector 408 of FIG. 4 may be configured to automatically select technical support information to provide to the sender of the support request in a response communication. Featurizer/selector 408 may also be configured to automatically select a recipient(s), such as a support group/team/engineer, to which the support request is to be provided, according to embodiments. The selected technical support information and/or the selected recipients may be retrieved from a database/data store, such as DB 406 of FIG. 4. Featurizer/selector 408 may be configured to select the technical support information and/or the recipients based on a service, product, and/or feature area that corresponds to the taxonomy determined as part of the model output of ML model 410 in step 306, and in embodiments, the technical support information and/or the recipients may be selected based on personalization for the sender.

In step 310, a second electronic communication is generated that includes the second information and the second electronic communication is provided to at least one of the sender or the recipient, and/or the first electronic communication is provided to the recipient. For example, responder 416 of FIG. 4 may be configured to generate an electronic communication for reply to the sender of the support request that includes technical support information as determined in step 308 by featurizer/selector 408. In embodiments, the electronic communication for reply to the sender may also be provided to the determined recipient for support assistance/resolution. Responder 416 may also be configured to provide the support request to the determined recipient, e.g., in cases of first impression for technical/support issues in which similar issues have never before been provided in electronic communications. Second electronic communications may also be personalized for the sender, as described herein.

In providing the electronic communication for reply to the sender (and/or to the recipient) and providing the support request to the recipient, responder 416 is configured to provide communications and requests via transmitter 418, described above.

By one or more of the steps of flowchart 300, recipients are predicted, and technical support information obtained, for automatic and intelligent electronic communication support, e.g., for technical support requests. By intelligently and automatically determining recipients and technical support information for the routing of and responding to support requests, load due to mis-routings is significantly reduced for the network utilized by technical support groups and the associated recipients. Additionally, TTE and TTR are reduced thereby improving productivity and operations of features/products/systems/services for which support request are provided. Accordingly, the embodiments and techniques described herein provide improved performance of computing devices and operations executing thereon.

As noted above, systems and devices may be configured and enabled in various ways to perform their respective functions according to the techniques described herein. In FIG. 5, a flowchart 500 for performing automatic and intelligent electronic communication support is shown, according to an example embodiment. For purposes of illustration, flowchart 500 of FIG. 5 is described with respect to system 200 of FIG. 2 and its subcomponents, and also with reference to system 400 of FIG. 4. That is, system 200 of FIG. 2 and system 400 of FIG. 4 may perform their various functions and operations in accordance with flowchart 500 for automatic and intelligent electronic communication support. Further structural and operational examples will be apparent to persons skilled in the relevant art(s) based on the following description. Flowchart 500 is described as follows.

Flowchart 500 begins at step 502. In step 502, first information is received in a first electronic communication comprising a technical support request from a sender. For instance, as noted above, a sender may provide an electronic communication support request with information related to the technical support request via a communication client as described with respect to FIG. 1. The support request may be an email support request that is received by server 402 of FIG. 4. Notifier 404 is configured to monitor incoming support requests received, and save such support requests to DB 406 and also provide them to featurizer/selector 408. Information in the technical support request may be included in the subject line or the body of the electronic communication, and may comprise text describing the problem experienced by the sender, services or products related to the problem, images/screenshots, error messages/code, dates/times, solutions attempted by the sender, attachments, and/or the like.

In step 504, featurization is applied to the first information according to at least one featurization operation to generate a feature vector. For example, featurizer/selector 408 of FIG. 4 may be configured to generate a feature vector for a support request based on the information provided and received in step 502 in the support request. Featurizer/selector 408 may be configured to perform one or more featurization operations such as, but not limited to, a K-means clustering featurization, a keyword featurization, a content-based featurization, a context-based featurization, a semantic-based featurization, an n-gram featurization, a skip-gram featurization, a bag of words featurization, a char-gram featurization, and/or a feature selection featurization for data, attachments, text, etc., included in the support request (including the subject and/or body of a support request message). Feature vectors generated may comprise any number of feature values (i.e., dimensions) from tens, hundreds, thousands, etc., of feature values in the feature vector.

For instance, clustering may be based on a fixed “K” thread or may be based on dynamically determined “K” threads for processing based on cohesiveness of the data provided. Additionally, any number of keywords may be used by featurizer/selector 408 in determining a keyword portion of the feature vector (e.g., any number of Boolean entries for pre-determined keywords either being present or not present in the information). Context- and semantic-based featurization may also be performed by featurizer/selector 408 to provide structure to unstructured information that is received. N-gram, skip-gram and char-gram featurizations may also be implemented to determine numbers of word and/or character groups present in the information, and count- and/or correlation-based feature selection as featurization may also be performed by featurizer/selector 408 on text associated with the information received in step 502 to determine if system/service features are present and designate such system/service features in the feature vector.

In step 506, a set of prior communications related to the technical support request is automatically determined based on a measure of similarity between the feature vector and feature vectors associated with the set of prior communications. For example, as noted above, locator 412 may be configured to locate and later retrieve one or more stored electronic communications related to support requests, including communication threads, suggested resolutions of the support request, and/or subsequent communication interactions between the sender, support personnel, and/or components of system 400. In embodiments, locator 412 receives a feature vector for a received support request from featurizer/selector 408 to determine stored electronic communications that are similar to the received support request. In embodiments, locator 214 may be configured to utilize a nearest neighbor (kNN) model that is based on a cosine metric. For example, the kNN model configured to determine a previously-received electronic communication(s) associated with a previously-determined resolution related to a support request. In some embodiments, locator 412 utilizes API 414 for performing its functions and operations for step 506. Locator 412 may compare the feature vector of the received support request to feature vectors of stored electronic communications/support requests to determine similarities thereof, and locate/retrieve the associated, stored electronic communications/support requests via API 414. Accordingly, in embodiments, API 414 may be configured to access DB 406, or other system databases/data stores, for the described locating/retrieving.

In embodiments, locator 412 may retrieve actual electronic communications/threads themselves to provide back to featurizer/selector 408, and/or may provide links to the electronic communications/threads back to featurizer/selector 408 which, when provided to the sender as described below, allow the sender to access the electronic communications/threads or content related thereto.

In step 508, second information associated with the technical support request is automatically selected from the set of prior communications. For instance, locator 412 of FIG. 4 may be configured to automatically select technical support information from the located prior communications of step 506 to provide to the sender of the support request in a response communication, in embodiments. The selected technical support information may be retrieved from prior communications, including communication threads, suggested resolutions of the support request, and/or subsequent communication interactions between the sender, support personnel, and/or components of system 400, in a database/data store, such as DB 406 of FIG. 4. Links to selected technical support information may be generated, retrieved, and/or provided in addition to, or in lieu of, the actual support information itself. Locator 412 may be configured to provide located communications/threads, technical support information, and/or links to featurizer/selector 408, according to embodiments, although it is also contemplated herein that such provision(s) may be made directly to responder 416.

In some embodiments, featurizer/selector 408 may be configured to automatically select a recipient(s), such as a support group/team/engineer, which will included in a response communication to the sender. Additionally, featurizer/selector 408 may also be configured to retrieve other technical support information, e.g., from FAQs, wiki help pages, other network-accessible technical support sources, etc., to include in a response communication to the sender. In embodiments, technical support information and/or recipients may be selected based on personalization for the sender.

In step 510, a second electronic communication is generated that includes the second information, and the second electronic communication is provided to the sender. For example, responder 416 of FIG. 4 may be configured to generate an electronic communication for reply to the sender of the support request that includes technical support information as determined in step 508. In embodiments, the electronic communication for reply to the sender may also be provided to a determined recipient for support assistance/resolution. In providing the electronic communication with technical support information for reply to the sender (and/or to the recipient), responder 416 is configured to personalize the electronic communication and/or to provide communications and requests via transmitter 418, described above.

In embodiments, the located second information, a portion thereof, and/or links may be annotated, highlighted by color, animation, and/or font variation, etc., for drawing the attention of the sender to the suggested support information.

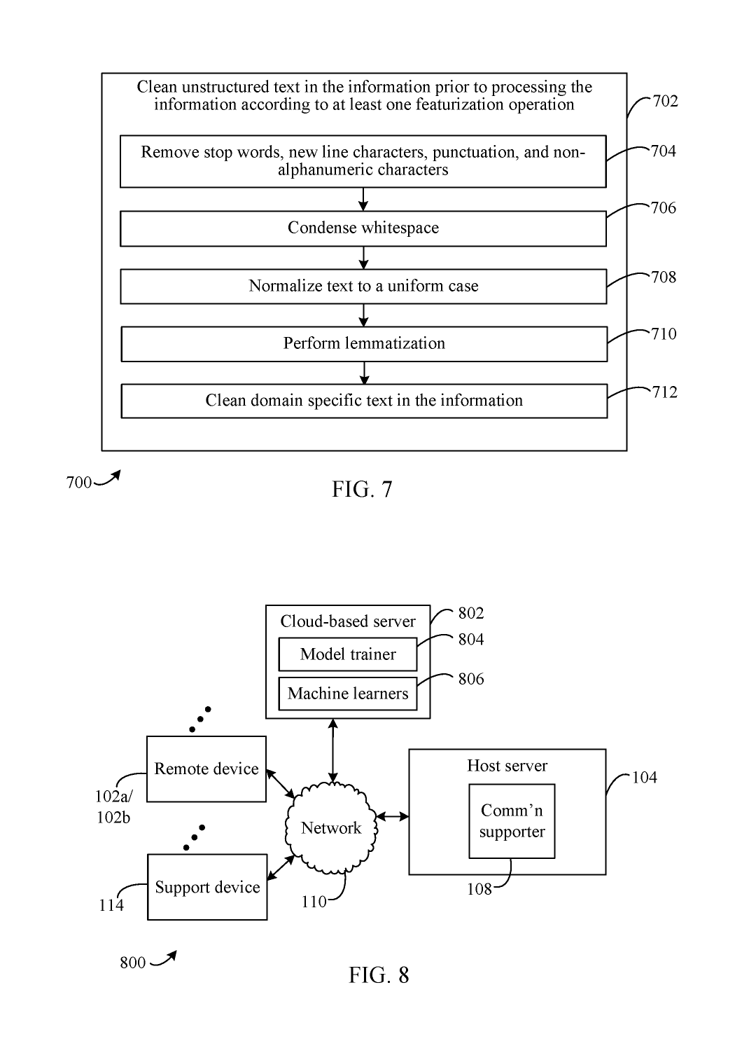

Referring now to FIG. 6 and FIG. 7, in FIG. 6 a flow diagram 600 for performing automatic and intelligent electronic communication support is shown, according to an example embodiment. In FIG. 7, a flowchart 700 for performing automatic and intelligent electronic communication support is shown, according to an example embodiment. For purposes of illustration, flow diagram 600 of FIG. 6 and flowchart 700 are described with respect to system 200 of FIG. 2 and system 400 of FIG. 4, and their respective subcomponents, and also with reference to the flowcharts of FIGS. 3 & 5. That is, system 200 of FIG. 2 and system 400 of FIG. 4 may perform various functions and operations for in accordance with flow diagram 600 and flowchart 700. Flow diagram 600 and/or flowchart 700 may be further embodiments of the flowcharts of FIGS. 3 & 5. Further structural and operational examples will be apparent to persons skilled in the relevant art(s) based on the following description. While some components of embodiments described herein are not illustrated in the example embodiment shown in FIG. 6 for purposes of brevity and illustrative clarity, it is contemplated that such components may be included within the representation of flow diagram 600.

Flow diagram 600 is described as follows. Flow diagram 600 includes a training portion 602 (e.g., for offline training and/or updating) that may be an embodiment of model trainer 220 of FIG. 2, and a deployment portion 604 (e.g., for “online prediction”) that may be an embodiment of communication supporter 208 of FIG. 2. In embodiments, a trained machine-learning model from training portion 602 may be used by deployment portion 604 for selections/predictions, and feature vectors generated by deployment portion 604 may be used by training portion 602 to train/update machine-learning models. Deployment portion 604 of flow diagram 600 is described first, while training portion 602 is described in the Section below.

Deployment portion 604 of flow diagram 600 begins with the receipt of a new support request 628 (“support request”) (e.g., an electronic communication including information related to a technical support request), as described herein. Support request may be received by a computing device such as computing device 202 of FIG. 2 and/or a server such as server 402 of FIG. 4. In embodiments, support request 628 may be an email support request. Support request 620 may be provided to a cleaner 630. Cleaner 630 may be a further embodiment of cleaner 226 of FIG. 2. That is, cleaner 630 may be configured to perform cleaning operations on the information received in electronic communication support requests. Cleaning operations may include one or more of character or word removal (including tags for markup and/or programming languages and long base64 strings, e.g., for image text), lemmatization, whitespace condensing, and/or, case normalization, and may be performed to provide initial structure to unstructured information, e.g., textual information, and to remove extraneous characters and/or redundancies from the information.

Referring now to FIG. 7 and flowchart 700, example steps for cleaning operations are shown. Flowchart 700 begins at step 702 and is described as follows.

In step 702, unstructured text in the information is cleaned prior to processing the information according to at least one featurization operation. For instance, as described herein, electronic communication support requests are provided by senders with relevant information for problems/issues experienced by the senders. This information may comprise unstructured text describing the problem experienced by the sender, services or products related to the problem, images/screenshots, error messages/code, dates/times, solutions attempted by the sender, and/or the like. According to embodiments, the information is processed according to at least one featurization operation to generate a feature vector (e.g., step 304 of flowchart 300 of FIG. 3; step 504 of flowchart 500 of FIG. 5). Subsequent to provision and receipt of the information from the sender, the information may be cleaned. According to embodiments, cleaner 226 of FIG. 2, cleaner 608 of FIG. 6, and/or cleaner 630 of FIG. 6 may be configured to perform cleaning operations on the information, as noted above.

It is contemplated herein that one or more of the following cleaning steps of flowchart 700 may be performed in a different order or may be omitted, in some embodiments, and/or that other cleaning operations may be performed. Step 704, step 706, step 708, step 710, and/or step 712 may be performed as part of step 702.

In step 704, stop words, new line characters, punctuation, and non-alphanumeric characters are removed. For example, cleaner 226 of FIG. 2, cleaner 608 of FIG. 6, and/or cleaner 630 of FIG. 6 may be configured to remove any number of stop words such as “the,” “a,” “and,” etc., in addition to stop words that are specific to the domain of the system (e.g., system 100 of FIG. 1, system 200 of FIG. 2, and/or system 400 of FIG. 4). Cleaner 226 of FIG. 2, cleaner 608 of FIG. 6, and/or cleaner 630 of FIG. 6 may be configured to remove punctuation, e.g., commas, periods, semicolons, etc., from the information as well as any non-alphanumeric characters, in embodiments. New line characters may also be removed by cleaner 226 of FIG. 2, cleaner 608 of FIG. 6, and/or cleaner 630 of FIG. 6. Such cleaning operations may simplify the data set from which a feature vector is generated.

In step 706, whitespace is condensed. For instance, removal of white space condenses the information for feature vector generation, which reduces memory footprints and necessary processing cycles, and also provides for a uniform delimiting of terms in the information. According to embodiments, cleaner 226 of FIG. 2, cleaner 608 of FIG. 6, and/or cleaner 630 of FIG. 6 may be configured to perform this cleaning operation.

In step 708, the text is normalized to a uniform case. For example, cleaner 226 of FIG. 2, cleaner 608 of FIG. 6, and/or cleaner 630 of FIG. 6 may be configured to normalize text in the information to a single case, e.g., either upper case or lower case. Uniform, normalized case information may allow for a simplification in generating feature vectors, as described herein.

In step 710, lemmatization is performed. For instance, cleaner 226 of FIG. 2, cleaner 608 of FIG. 6, and/or cleaner 630 of FIG. 6 may be configured to perform lemmatization to reduce redundancy of words having the same root base that are used in different forms to simplify and further condense the data provided in the information, e.g., “access,” “accessing,” “accessed,” etc., may be lemmatized to simply “access.”

The cleaned information may be respectively provided by cleaner 226 of FIG. 2, cleaner 608 of FIG. 6, and/or cleaner 630 of FIG. 6 to a featurizer for featurization processing, as described herein.

Accordingly, cleaner 226 of FIG. 2, cleaner 608 of FIG. 6, and/or cleaner 630 of FIG. 6 is configured to provide increased classification efficiency and decreased classification complexity to improve the performance of the systems/devices and methods here for generating feature vectors, determining classifications, and predicting recipients for automatic and intelligent electronic communication support. That is, the cleaning operations described herein allow for a smaller memory footprint by reducing and simplifying input information, as well as reducing processing cycles required by systems/devices in performance of the techniques described herein.

Referring again to flow diagram 600 of FIG. 6, cleaned information is provided from cleaner 630 to featurizer 632 which may be a further embodiment of featurizer 210 of FIG. 2 and/or of featurizer/selector 408 of FIG. 4. That is, featurizer 632 may perform one or more of the featurization operations described herein. As illustrated, featurizer 632 includes a keyword extractor 634, a semantics extractor 636, a counter 638, and an n-grams component 640. As an illustrative example, featurizer 632 may take cleaned information from support request 628, or a portion thereof, via cleaner 630 as an input and perform a featurization operation(s) to generate a representative output value(s)/term(s) associated with the type of featurization performed, where this output may be an element(s)/a dimension(s) of the feature vector.

Additionally, any number of keywords (or keyphrases) may be used by keyword extractor 634 of featurizer 632 in determining a keyword portion of the feature vector (e.g., any number of Boolean entries for pre-determined keywords either being present or not present in the information).

Context- and semantic-based featurization may also be performed by featurizer 632, using semantics extractor 636 to provide structure to unstructured information that is received. In embodiments, semantics extractor 636 may utilize the SysSieve learning system from Microsoft Corporation of Redmond, Wash., for semantic-based featurizations. For example, semantic-based feature sets may be extracted by semantics extractor 636 for technical phrases from the support request information provided by the sender. Sematic-based features sets may comprise, without limitation, domain-specific information and terms such as global unique identifiers (GUIDs), universal resource locators (URLs), emails, error codes, customer/user identities, geography, times/timestamps, and/or the like. The use of semantic-based featurization for domain-specific features provides rich, discriminative sets of features that improve accuracy in service/recipient determinations.

Counter 638 of featurizer 632 may be configured to count alphanumeric characters present in a support request to determine a length or size of the request and the information provided therein, e.g., a size in bytes for the request, for the feature vector. Counter 638 may also be configured to determine a ratio of digits-to-alphabetic characters for inclusion in the feature vector.

N-gram, skip-gram and char-gram featurizations may also be implemented by n-grams component 640 of featurizer 632 to determine numbers of word and/or character groups present in the information, and count- and/or correlation-based feature selection as featurization may also be performed by n-grams component 640 of featurizer 632 on text associated with the information received in support requests to determine if system/service features are present and designate such system/service features in the feature vector. In embodiments, featurizations performed by featurizer 610 may also include a bag-of-words transform applied to the information of support request 628.

A feature vector may be created using the above featurizations (e.g., featurization operations) by setting a bit(s) and/or a value in the feature vector for descriptive support request information and for results of the featurization steps described herein, e.g., if a key phrase/word is present in the support request information.

Featurizer 632 is configured to provide a feature vector 642 for the support request, as an output, to selector 644 which may be a further embodiment of selector 212 of FIG. 2 and/or of featurizer/selector 408 of FIG. 4. For example, selector 644 may be configured to automatically determine a recipient, e.g., support personnel, for received support request 628 based on feature vector 642 from featurizer 632. Selector 644 is configured to processes the feature vector according to an algorithm or model, such as an ML model 624, described in further detail below. According to embodiments, selector 644 may be a classifier such as a machine-learning classifier that utilizes machine learning techniques based on a learning model or classification model. Selector 644 may be configured to automatically select/retrieve technical support information stored in a database based on feature vector 642 for responding to received support request 628 and/or based on the prediction of the recipient according to model ML model 624. Information regarding recipients and technical support are provided to responder 646.

Responder 646 may be a further embodiment of responder 230 of FIG. 2 and/or of responder 416. That is, responder 646 may be configured to automatically generate an electronic message(s), based on information received from selector 644, that automatically respond to received support request 628 and/or to provide received support request 628 to recipients, according to embodiments. Flow diagram 600, and in particular, model portion 602, is described in further detail in the following Section.

### B. Example Embodiments for Modeling

The embodiments and techniques also provide for training and updating models/algorithms utilized by machine learning classifiers, as described herein. Embodiments and techniques may also provide for alternative configurations for training models/algorithms utilized by machine learning classifiers.

Referring again to flow diagram 600 of FIG. 6, training portion 602 of flow diagram 600 begins with the receipt of training data/testing data 606 (“data 606”). Data 606 may comprise previously-received support requests and/or resolutions, senders and recipients thereof, as well as communication threads thereof, a priori information, tailored support requests, etc., divided into known categories/taxonomies corresponding to self-help content for previously-identified problems/issues (e.g., “training data”). Data 606, or a portion thereof, may also be tagged with class labels as “testing data” or “training data” for modeling purposes. In embodiments, when prior support requests and response communications for resolution are identified for new support requests received, as described herein, the start and end indices for answer strings in the prior responses may be annotated as training data. Data 606 may be provided to a cleaner 608.

Cleaner 608 may be an identical instance of cleaner 630, in embodiments. For example, cleaning operations performed for generating/updating models may the same as, or substantially similar to, cleaning operations performed for deployment portion 604. However, it is contemplated that cleaner 608 may perform any cleaning operations described herein. According to embodiments, cleaner 630 may be configured to perform cleaning operations on the information received in training data 606. That is, cleaner 630 may perform cleaning operations according to flowchart 700 of FIG. 7. Cleaning operations may include one or more of character or word removal (including tags for markup and/or programming languages and long base64 strings, e.g., for image text), lemmatization, whitespace condensing, and/or, case normalization, and may be performed to provide initial structure to unstructured information, e.g., textual information, and to remove extraneous characters and/or redundancies from the information.

A portion of the cleaned information (e.g., unlabeled or “training”-labeled portions of data 606) is provided from cleaner 608 to featurizer 610 which may be an identical instance of featurizer 632, in embodiments, and a “testing” labeled portion of data 606 is provided to an evaluator 626, in embodiments. For example, featurization operations performed for generating/updating models may the same as, or substantially similar to, featurization operations performed for deployment portion 604. For example, featurizer 610 includes a keyword extractor 612, a semantics extractor 614, a counter 616, and an n-grams component 618 each being configured similarly as the corresponding components of deployment portion 604 of flow diagram 600 (i.e., keyword extractor 634, semantics extractor 636, counter 638, and n-grams component 640). However, it is contemplated that featurizer 610 may perform any featurization operations described herein. As an illustrative example, featurizer 610 may take cleaned information from data 606, or a portion thereof, via cleaner 608 as an input and perform a featurization operation(s) to generate a representative output value(s)/term(s) associated with the type of featurization performed, where these outputs, for portions/instances of data 606, may be an element(s)/a dimension(s) of the feature vectors corresponding to the portions/instances of data 606.

Featurizer 610 is configured to provide a set of feature vectors 620 for data 606, as an output, to an ML model trainer 622. ML model trainer 622 may be a machine-learning trainer, such as a One-versus-All Fast Linear (Stochastic Dual Coordinate Ascent—SDCA) model trained with the TLC machine-learning tool from Microsoft Corporation of Redmond, Wash., although any other type of model and machine-learning tool are also contemplated herein, such as but without limitation, one-versus-all averaged perceptron and one-versus-all fast tree, one-versus-one machine learners, neural networks, K nearest neighbor learners, as well as equivalent, similar, and/or other machine learners, and/or the like, including the use of multiple models. The output of ML model trainer 622 is ML model 624. ML model 624 may be an embodiment of model 222 of FIG. 2 and/or of ML model 410 of FIG. 4. In embodiments, ML model 624 is configured to be personalized for specific senders, as described herein.

In embodiment, ML model 624 may be provided to, or utilized by, selector 644 as described herein. Additionally, feature vector 642 from deployment portion 604 may be provided as one of the set of feature vectors 620 for updating ML model 624.

Evaluator 626 is configured to receive information related to ML model 624, or the model itself, and perform evaluations of ML model 624 using the received “testing” data portion of data 606, in embodiments. For instance, known portions of data 606 can be anticipated as yielding expected results from ML model 624 (e.g., for recipient prediction). As the body of testing data grows, or for initial training purposes, evaluator 626 is configured to adjust, add, remove, etc., featurization operations/parameters of featurizer 610 in order to train, update, fine-tune, etc., the resulting ML model 624. Evaluator 626 is also configured to receive accuracy feedback 648 from senders of support requests. Accuracy feedback 648 may be associated with the technical support information received by a sender from a response communication from responder 648. In embodiments, accuracy feedback 648 may include an efficacy rating for the second information from the sender, a number of communications including the first communication and the second communication that have been exchanged between the sender and the recipient for a resolution, and/or a lack of a response from the sender to the second electronic communication. In some embodiments, accuracy feedback 648 may include system-side information such as, but without limitation, an amount of time elapsed between the provision of the first electronic communication to the recipient and when the recipient takes an action in response to the first electronic communication, the feature vector and the model output, or recipient feedback for automatically generated responses.

In another example embodiment, a cloud-based trainer for machine learning models/algorithms executing on a cloud-based server may train and/or update models/algorithms based on provided data, according to embodiments. This provided data may include one or more of prior support requests/resolutions for features/systems/services, “big data,” bulk data stores for support teams, and/or the like.

FIG. 8 shows a block diagram of a system 800 for cloud-based model/algorithm training and updating, according to an example embodiment. As illustrated, system 800 may be a further embodiment of system 100 of FIG. 1 (having remote device(s) 102a/b, support device 114, and host server 104 (with communication supporter 108) communicatively configured via network 110). System 800 also includes a cloud-based server 802 which may be any type of server computer, including distributed server systems, according to embodiments. Cloud-based server 802 may be communicatively coupled to host sever 104 via network 110, and may reside “in the cloud” as would be understood by one of skill in the relevant art(s) having the benefit of this disclosure.

Cloud-based server 802 includes a model trainer 804 that may be a further embodiment of model trainer 220 of system 200 in FIG. 2, and/or of ML model trainer 622 of training portion 602 in FIG. 6. That is, model trainer 804 may be configured to train and/or update models, such as but not limited to, classification models/algorithms to be used for performing automatic and intelligent electronic communication support. Cloud-based server 802 also includes one or more machine learners 806. Machine learners 806 may include any number of machine learners. While not shown above in system 200 of FIG. 2, system 400 of FIG. 4, and flow diagram 600 of FIG. 6, it is contemplated herein that devices and system may also include one or more machine learners such as machine learners 806 for use in conjunction with model trainers, according to embodiments.

Models/algorithms, such as classification models/algorithms, may be trained offline for deployment and utilization as described herein, according to one or more featurization operations described herein for structuring input data and determining feature vectors, and model trainer 804 may be configured to train models/algorithms using described machine learning techniques, according to embodiments. The techniques and embodiments herein may also operate according to one or more machine learning models/algorithms, such as, but without limitation, ones of the MicrosoftML machine learning models/algorithms package, Microsoft® Azure® machine learning models/algorithms, etc., from Microsoft Corporation of Redmond, Wash.

In a further model training embodiment, extracted step-by-step solutions from recommend self-help links and related communication threads, as noted herein, may be recommended to senders for resolution of support requests. The techniques and embodiments herein also provide for building and training Build an attention-based recurrent neural network (RNN) model to learn to locate answers for support requests in prior communication threads.

For example, the start and end indices for answer strings in past communication responses may be annotated as training data for the RNN model. Accordingly, the RNN model may be built based at least in part on these candidate responses/threads. Character, word, and phrase level attributes may be extracted based embedding layers to use as inputs. Given an incoming support request, the list of similar past communications may be extracted. This extraction may be based on similarity measures (e.g., using a cosine metric on word features, TF-IDF, as similarly described herein) based on both of support request and response/answer content. Using the list of responses to the similar, prior communications as input, the beginning and end indices of the answer can be predicted using the RNN model, and the answer may be highlighted for the user in a response communication generated by a responder, according to embodiments.

### III. Example Mobile Device Implementation

Portions of system 100 of FIG. 1, system 200 of FIG. 2, system 400 of FIG. 4, flow diagram 600 of FIG. 6, system 700 of FIG. 7, system 800 of FIG. 8, along with any components and/or subcomponents thereof, as well as the flowcharts/flow diagrams described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 9 is a block diagram of an exemplary mobile system 900 that includes a mobile device 902 that may implement embodiments described herein. For example, mobile device 902 may be used to implement any system, client, or device, or components/subcomponents thereof, in the preceding sections. As shown in FIG. 9, mobile device 902 includes a variety of optional hardware and software components. Any component in mobile device 902 can communicate with any other component, although not all connections are shown for ease of illustration. Mobile device 902 can be any of a variety of computing devices (e.g., cell phone, smart phone, handheld computer, Personal Digital Assistant (PDA), etc.) and can allow wireless two-way communications with one or more mobile communications networks 904, such as a cellular or satellite network, or with a local area or wide area network.

Mobile device 902 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components of mobile device 902 and provide support for one or more application programs 914 (also referred to as “applications” or “apps”). Application programs 914 may include common mobile computing applications (e.g., e-mail applications, calendars, contact managers, web browsers, messaging applications) and any other computing applications (e.g., word processing applications, mapping applications, media player applications).

Mobile device 902 can include memory 920. Memory 920 can include non-removable memory 922 and/or removable memory 924. Non-removable memory 922 can include RAM, ROM, flash memory, a hard disk, or other well-known memory devices or technologies. Removable memory 924 can include flash memory or a Subscriber Identity Module (SIM) card, which is well known in GSM communication systems, or other well-known memory devices or technologies, such as “smart cards.” Memory 920 can be used for storing data and/or code for running operating system 912 and application programs 914. Example data can include web pages, text, images, sound files, video data, or other data to be sent to and/or received from one or more network servers or other devices via one or more wired or wireless networks. Memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 920. These programs include operating system 912, one or more application programs 914, and other program modules and program data. Examples of such application programs or program modules may include, for example, computer program logic (e.g., computer program code or instructions) for implementing one or more of system 100 of FIG. 1, system 200 of FIG. 2, system 400 of FIG. 4, flow diagram 600 of FIG. 6, system 700 of FIG. 7, system 800 of FIG. 8, along with any components and/or subcomponents thereof, as well as the flowcharts/flow diagrams described herein and/or further examples described herein.

Mobile device 902 can support one or more input devices 930, such as a touch screen 932, a microphone 934, a camera 936, a physical keyboard 938 and/or a trackball 940 and one or more output devices 950, such as a speaker 952 and a display 954. Other possible output devices (not shown) can include piezoelectric or other haptic output devices. Some devices can serve more than one input/output function. For example, touch screen 932 and display 954 can be combined in a single input/output device. Input devices 930 can include a Natural User Interface (NUI).

Wireless modem(s) 960 can be coupled to antenna(s) (not shown) and can support two-way communications between processor 910 and external devices, as is well understood in the art. Modem(s) 960 are shown generically and can include a cellular modem 966 for communicating with the mobile communication network 904 and/or other radio-based modems (e.g., Bluetooth 964 and/or Wi-Fi 962). At least one of wireless modem(s) 960 is typically configured for communication with one or more cellular networks, such as a GSM network for data and voice communications within a single cellular network, between cellular networks, or between the mobile device and a public switched telephone network (PSTN).

Mobile device 902 can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components of mobile device 902 are not required or all-inclusive, as any components can be deleted and other components can be added as would be recognized by one skilled in the art.

In an embodiment, mobile device 902 is configured to implement any of the above-described features of flowcharts herein. Computer program logic for performing any of the operations, steps, and/or functions described herein may be stored in memory 920 and executed by processor 910.

### IV. Example Processor-Based Computer System Implementation

As noted herein, the embodiments and techniques described herein, including system 100 of FIG. 1, system 200 of FIG. 2, system 400 of FIG. 4, flow diagram 600 of FIG. 6, system 700 of FIG. 7, system 800 of FIG. 8, along with any components and/or subcomponents thereof, as well as the flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), or an application specific integrated circuit (ASIC).

FIG. 10 depicts an example processor-based computer system 1000 that may be used to implement various example embodiments described herein. For example, system 1000 may be used to implement any server, host, system, device (e.g., a remote device), mobile/personal device, etc., as described herein. System 1000 may also be used to implement any of the steps of any of the flowcharts, as described herein. The description of system 1000 provided herein is provided for purposes of illustration, and is not intended to be limiting. Embodiments may be implemented in further types of computer systems, as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing system 100 of FIG. 1, system 200 of FIG. 2, system 400 of FIG. 4, flow diagram 600 of FIG. 6, system 700 of FIG. 7, system 800 of FIG. 8, along with any components and/or subcomponents thereof, as well as the flowcharts/flow diagrams described herein and/or further examples described herein.

A user may enter commands and information into the computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1006 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium” are used to refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media and modulated data signals (do not include communication media and modulated data signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1000.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Additional Example Advantages and Embodiments

As described, systems and devices embodying the techniques herein may be configured and enabled in various ways to perform their respective functions. In embodiments, one or more of the steps or operations of any flowchart and/or flow diagram described herein may not be performed. Moreover, steps or operations in addition to or in lieu of those in any flowchart and/or flow diagram described herein may be performed. Further, in examples, one or more operations of any flowchart and/or flow diagram described herein may be performed out of order, in an alternate sequence, or partially (or completely) concurrently with each other or with other operations.

In embodiments, feature/product/service/system owners and/or teams, e.g., recipients of support requests, may be notified about tasks/work items in their respective areas of support provision. For example, tasks/work items may include support requests as described herein. The techniques and embodiments described provide for a digest summary (e.g., updated hourly, daily, or otherwise) of support request that may be provided to the owning teams/engineers for each of the categories of support requests.

FIG. 11, shows a diagram of an interface 1100 for intelligent and automatic electronic communication support, according to an example embodiment. Interface 1100 may be an example digest summary. For example, a recipient, as described herein, may receive one or more support requests for which the recipient is determined as the owning/responsible party. These support requests may be displayed to the recipient in interface 1100. Interface 1100 includes a dashboard 1102 and a listing section 1104. Dashboard 1102 may include selectable options, e.g., buttons, allowing or enabling the recipient to perform different operations, such as and without limitation, creating a support request, searching for a support request(s), replying to or forwarding a support request(s), providing feedback for automatically and intelligently generated responses to a support request(s), viewing metrics grading automatically and intelligently generated responses to a support request(s), and/or marking a support request(s) as resolved.

Listing section 1104 may include a list of support requests for which the recipient is the owner. Listing section 1104 may organize and display multiple support requests in a single list that may be viewed and/or ordered according to attributes, such as but not limited to, Date/Time, Category, Sender, Subject, Body, and/or Urgency. Urgency may be indicated by highlighting, use of icons, and/or the like.

According to embodiments, support requests may be related to bugs or similar issues with features/products/systems/services utilized by the sender of the support request. The described techniques and embodiments may be extended to support reproduction of bugs for bug fixes, as well as bolstering testing suites run against these features/products/systems/services. For example, as noted above, a sender may include steps they have taken in attempt to solve their problem. In embodiments, the user-/sender-supplied steps may be extracted from the support request to reproduce the user's problem(s) by support staff. Screenshots associated with user/sender problems that are included in support requests may be processed according to optical character recognition (OCR) techniques to scrape information related to the problem. In this way, screenshot information, in addition to text provided by the sender, may be extracted to determine prior actions taken by the sender, information about the nature of the problem itself, etc., as a basis for resolving the support request and future testing. In furtherance of this embodiment, one or more of the following may be performed: annotating responses to past support requests to indicate the reproduction steps for users/senders (e.g., to be provided in response communications), using a recurrent neural network(s) (RNN) model to extract user/sender actions described by text in the support request or from OCR text of images, using the RNN model to extract user/sender actions for support requests classified as a bug, and automatically creating tests based on the steps extracted from the model.

The embodiments and techniques described herein provide improved performance of computing devices and operations executing thereon. By one or more of the techniques and embodiments described, recipients are predicted and technical support information is obtained intelligent and automatic electronic communication support, including using machine-learning, e.g., for support requests, in ways that reduce usage for system resources and also improve system operations. For instance, as noted above, the number of possible recipients for support requests may vary greatly from a relatively small number to thousands of support groups, staff members, and/or engineers. The recipients, according the techniques and embodiments herein, are intelligently and automatically predicted based on an incoming support request and stored support request communication threads. By intelligently and automatically determining recipients for the routing of and responding to support requests, load due to mis-routings is significantly reduced for the network utilized by technical support groups and the associated recipients. Additionally, TTE and TTR are reduced thereby improving productivity and operations of features/products/systems/services for which support requests are provided by senders. That is, issues for features/products/systems/services accessed by senders may be timely mitigated thus increasing both features/products/system/service operational efficiency as well as operational quality.

Additionally, cleaning operations provide initial structure to unstructured information, e.g., textual information, remove extraneous characters and/or redundancies from the information, and simplify the data sets from which feature vectors are generated. Removal of white space condenses the information for feature vector generation, which reduces memory footprints and necessary processing cycles, and also provides for a uniform delimiting of terms in the information. In other words, the techniques and embodiments herein provide for increased algorithm efficiency and decreased algorithm complexity to improve the performance of systems for generating feature vectors, determining algorithm outputs, and providing recipients and technical support information for automatic and intelligent electronic communication support, including using machine learning. Smaller memory footprints are provided for by reducing and simplifying input information, and processing cycles required by systems in performance of the techniques described herein are also reduced.

The additional examples described in this Section may be applicable to examples disclosed in any other Section or subsection of this disclosure.

A system is also described herein. The system may be for automatic and intelligent electronic communication support, including using machine learning. In an embodiment, the system includes at least one memory configured to store program logic for automated communication servicing, and at least one processor configured to access the memory and to execute the program logic. In the embodiment, the program logic includes featurization logic configured to apply featurization to first information according to at least one featurization operation to generate a feature vector, the first information being received in a first electronic communication from a sender, the first electronic communication comprising a request. The program logic also includes selector logic configured to provide the feature vector as an input to a machine-learning model that automatically determines a model output based on the feature vector, and based at least in part on the model output, automatically select one or more of second information from a plurality of support information or a recipient from a plurality of possible recipients. The program logic also includes transmitter logic configured to provide a second electronic communication that includes the second information to one or more of the sender or the recipient and/or to provide the first electronic communication to the recipient.

In an embodiment of the system, the model is a classifier and the model output is a classification for the first electronic communication, the model is a regression model and the model output is a statistical probability for the first electronic communication, the model is a clustering model and the model output is a cluster group for the first electronic communication, and/or the model is a comparison model and the model output is a measure of similarity for the first electronic communication against one or more stored electronic communications.

In an embodiment of the system, featurization includes performing at least one featurization operation that transforms at least a portion of the first information into one or more representations that describe characteristics of the at least a portion of the first information. In an embodiment of the system, the featurization logic is configured to perform the at least one featurization operation comprising one or more of a K-means clustering featurization, a keyword featurization, a content-based featurization, a semantic-based featurization, an n-gram featurization, a skip-gram featurization, a bag of words featurization, a char-gram featurization, and/or a feature selection featurization. In an embodiment of the system, the request may be one or more of an electronically mailed (emailed) support request, a technical support request, a posting on messaging thread or forum, a social media posting, an instant message, a conversation with automated mechanism, a billing request, feedback, or a notification.

In an embodiment of the system, the keyword featurization comprises a Boolean vector for a plurality of keywords or keyphrases. In an embodiment of the system, the content-based featurization comprises at least one electronic message attribute of a character count, a byte count, or a ratio of numeric to alphabetic characters. In an embodiment of the system, the semantic-based featurization comprises one or more triplet sets that each include an entity, and action, and a qualifier.

In an embodiment of the system, the featurization logic is further configured to determine the feature vector based on support reference information accessible through a network. In an embodiment of the system, the selector logic is further configured to determine an indication of urgency related to the first information in the first electronic communication provided to the recipient based on the feature vector. In an embodiment of the system, the program logic further comprises responder logic configured to include the indication of urgency in the first electronic communication provided to the recipient.

In an embodiment of the system, the second information comprises at least one communication-based portion, determined based on the feature vector, that includes a previously-determined resolution related to the request, one or more previously-received electronic communications associated with the previously-determined resolution, or a selectable link to a proposed resolution for the request, the selectable link being automatically generated based on a determination of the proposed resolution from the plurality of support information. In an embodiment of the system, the selector logic is further configured to determine a ranking for portions of the second information, and the program logic further includes responder logic configured to provide the portions of the second information in the second communication in an order according to the ranking.

In an embodiment of the system, at least one of the model output or the second communication is personalized to the sender based on one or more of a prior response sent to the sender, an effectiveness for resolution of a prior response sent to a different sender, a team membership or a service membership of the sender, a setting or preference of the sender, or an attribute of the sender.

In an embodiment of the system, the selector logic is configured to utilize an updated machine-learning model that is updated as an incremental update or as a full update based on feedback associated with the second electronic communication, the feedback being one or more of an efficacy rating for the second information from the sender, a number of communications including the first communication and the second communication that have been exchanged between the sender and the recipient for a resolution, a lack of a response from the sender to the second electronic communication, an amount of time elapsed between the provision of the first electronic communication to the recipient and when the recipient takes an action in response to the first electronic communication, or the feature vector and the model output.

Another system is also described herein. The system may be for automatic and intelligent electronic communication support, including using machine learning. In an embodiment, the system includes at least one memory configured to store program logic for automated communication servicing, and at least one processor configured to access the memory and to execute the program logic. In the embodiment, the program logic includes featurization logic configured to apply featurization to first information according to at least one featurization operation to generate a feature vector, the first information being received in a first electronic communication from a sender, the first electronic communication comprising a request. The program logic also includes locator logic configured to automatically determine a set of prior communications related to the request based on a measure of similarity between the feature vector and feature vectors associated with the set of prior communications, and automatically select second information associated with the request from the set of prior communications. The program logic also includes responder logic configured to generate a second electronic communication that includes the second information, and transmitter logic configured to provide the second electronic communication to the sender.

In an embodiment of the system, featurization includes performing at least one featurization operation that transforms at least a portion of the first information into one or more representations that describe characteristics of the at least a portion of the first information. In an embodiment of the system, the featurization logic is configured to perform the at least one featurization operation including one or more of a K-means clustering featurization, a keyword featurization, a content-based featurization, a semantic-based featurization, an n-gram featurization, a skip-gram featurization, a bag of words featurization, a char-gram featurization, or a feature selection featurization. In an embodiment of the system, the request may be one or more of an electronically mailed (emailed) support request, a technical support request, a posting on messaging thread or forum, a social media posting, an instant message, a conversation with automated mechanism, a billing request, feedback, or a notification. In an embodiment of the system, the measure of similarity is determined by a machine-learning comparison model.

In an embodiment of the system, the second information includes at least one of a previously-determined resolution related to the request, one or more previously-received electronic communications associated with the previously-determined resolution, or a selectable link to a proposed resolution for the request, the selectable link being automatically generated based on a determination of the proposed resolution. In an embodiment of the system, the responder logic is configured to provide portions of the second information in the second communication in an order according to the measure of similarity.

A method performed in a computing system is described herein. The method may be for automatic and intelligent electronic communication support, including using machine learning. In an embodiment, the method includes receiving a first electronic communication comprising a request from a sender, and performing at least one featurization operation for first information associated with the first electronic communication to generate a feature vector. The method also includes providing the feature vector as an input to a machine-learning model that automatically determines a model output based on the feature vector, and based at least on the model output, automatically selecting one or more of second information from a plurality of support information or a recipient from a plurality of possible recipients. The method further includes performing at least one of generating a second electronic communication that includes the second information and providing the second electronic communication to at least one of the sender or the recipient; or providing the first electronic communication to the recipient.

In an embodiment of the method, the model is a classifier and the model output is a classification for the first electronic communication. In an embodiment of the method, the model is a regression model and the model output is a statistical probability for the first electronic communication. In an embodiment of the method, the model is a clustering model and the model output is a cluster group for the first electronic communication. In an embodiment of the method, the model is a comparison model and the model output is a measure of similarity for the first electronic communication against one or more stored electronic communications.

In an embodiment of the method, a featurization operation is an operation that transforms at least a portion of the first information into one or more representations that describe characteristics of the at least a portion of the first information. In an embodiment of the method, the at least one featurization operation includes one or more of a K-means clustering featurization, a keyword featurization, a content-based featurization, a semantic-based featurization, an n-gram featurization, a skip-gram featurization, a bag of words featurization, a char-gram featurization, or a feature selection featurization. In an embodiment of the method, the request may be one or more of an electronically mailed (emailed) support request, a technical support request, a posting on messaging thread or forum, a social media posting, an instant message, a conversation with automated mechanism, a billing request, feedback, or a notification.

In an embodiment of the method, the keyword featurization comprises a Boolean vector for a plurality of keywords or keyphrases. In an embodiment of the method, the content-based featurization comprises at least one electronic message attribute of a character count, a byte count, or a ratio of numeric to alphabetic characters. In an embodiment of the method, the semantic-based featurization comprises one or more triplet sets that each include an entity, and action, and a qualifier.

In an embodiment of the method, generating the feature vector further includes at least one of generating the feature vector also based on support reference information accessible through a network, or generating the feature vector also based on a textual output of a character recognition operation performed for an attachment to the first electronic communication.

In an embodiment, the method further includes determining one or more previously-received electronic communications associated with a previously-determined resolution based on a measure of similarity between the feature vector and feature vectors associated with the one or more previously-received electronic communications. In the embodiment, the second information comprises at least one of a representation of the previously-determined resolution related to the request, at least one of the one or more previously-received electronic communications, or one or more previously-received and annotated electronic communications associated with the previously-determined resolution, where at least one answer string is annotated. In an embodiment of the method, the second information comprises a support reference portion including a step-by-step solution for the request, or a selectable link to a proposed resolution for the request.

In an embodiment of the method, the technical support request or the first information is related to a bug. In an embodiment, the method further includes extracting one or more descriptions of actions taken by the sender from the first information according to a neural network model and automatically generating at least one test against the bug based on the extracted one or more descriptions of actions.

In an embodiment, the method further includes obtaining feedback associated with the second electronic communication. The feedback includes one or more of an efficacy rating for the second information from the sender, a number of communications that have been exchanged between the sender and the recipient for a resolution, a lack of a response from the sender to the second electronic communication, an amount of time elapsed between the provision of the first electronic communication to the recipient and when the recipient takes an action in response to the first electronic communication, or the feature vector and the model output. In the embodiment, the method further includes updating the machine-learning model as an incremental update or as a full update based on the feedback.

In an embodiment, the method further includes at least one of cleaning unstructured text in the first information prior to processing the first information according to the at least one featurization operation, or determining the recipient further based on a prior electronic communication of the sender.

### VI. Conclusion

While various examples of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described examples, but should be defined only in accordance with the following claims and their equivalents.

What is claimed is:

1. A system comprising:
at least one memory configured to store program logic; and
at least one processor configured to access the memory and to execute the program logic, the program logic comprising:
featurization logic configured to:
apply featurization to first information to generate a feature vector, the first information being received in a first electronic communication from a sender;
selector logic configured to:
provide the feature vector as an input to a machine-learning model that automatically determines a model output based on the feature vector; and
based at least in part on the model output, automatically select one or more of second information from a plurality of support information or a recipient from a plurality of possible recipients; and
transmitter logic configured to perform at least one of:
provide a second electronic communication that includes the second information to one or more of the sender or the recipient; or
provide the first electronic communication to the recipient.

2. The system of claim 1, wherein the machine-learning model is a classifier, a regression model, a clustering model, or a comparison model.

3. The system of claim 1, wherein featurization includes performing at least one featurization operation that transforms at least a portion of the first information into one or more representations that describe characteristics of the at least a portion of the first information, the featurization logic being configured to perform the at least one featurization operation comprising one or more of:
a K-means clustering featurization;
a keyword featurization;
a content-based featurization;
a semantic-based featurization;
an n-gram featurization;
a skip-gram featurization;
a bag of words featurization;
a char-gram featurization; or
a feature selection featurization;
or
wherein the first electronic communication comprises one or more of:
an electronically mailed (emailed) support request;
a technical support request;
a posting on messaging thread or forum;
a social media posting;
an instant message;
a conversation with automated mechanism;
a billing request;
feedback; or
a notification.

4. The system of claim 3, wherein the keyword featurization comprises a representation for one or more of keywords or keyphrases;
wherein the content-based featurization comprises at least one electronic message attribute of a character count, a byte count, or a ratio of numeric to alphabetic characters; or
wherein the semantic-based featurization comprises one or more triplet sets that each include an entity, and action, and a qualifier.

5. The system of claim 1, wherein the featurization logic is further configured to determine the feature vector based on support reference information accessible through a network;
or
wherein the selector logic is further configured to determine an indication of urgency based on the feature vector, and wherein the program logic further comprises responder logic configured to include the indication of urgency in the first electronic communication provided to the recipient.

6. The system of claim 1, wherein the second information comprises at least one communication-based portion, determined based on the feature vector, comprising:
a previously-determined resolution,
one or more previously-received electronic communications, or
a selectable link to a proposed resolution, the selectable link being automatically generated based on a determination of the proposed resolution from the plurality of support information; and
wherein the selector logic is further configured to determine a ranking for portions of the second information, and wherein the program logic further comprises responder logic configured to provide the portions of the second information in the second communication in an order according to the ranking.

7. The system of claim 1, wherein at least one of the model output or the second communication is personalized to the sender based on one or more of:
a prior response sent to the sender;
an effectiveness for resolution of a prior response sent to a different sender;
a team membership or a service membership of the sender;
a setting or preference of the sender; or
an attribute of the sender.

8. The system of claim 1, wherein the selector logic is configured to utilize an updated machine-learning model that is updated as an incremental update or as a full update based on feedback associated with the second electronic communication, the feedback being one or more of:
an efficacy rating for the second information from the sender,
a number of communications including the first communication and the second communication that have been exchanged between the sender and the recipient for a resolution,
a lack of a response from the sender to the second electronic communication,
an amount of time elapsed between the provision of the first electronic communication to the recipient and when the recipient takes an action in response to the first electronic communication, or
the feature vector and the model output.

9. A system comprising:
at least one memory configured to store program logic; and
at least one processor configured to access the memory and to execute the program logic, the program logic comprising:
featurization logic configured to:
apply featurization to first information to generate a feature vector, the first information being received in a first electronic communication from a sender;
locator logic configured to:
automatically determine a set of prior communications based on a measure of similarity between the feature vector and feature vectors associated with the set of prior communications, and
automatically select second information from the set of prior communications;
responder logic configured to:
generate a second electronic communication that includes the second information; and
transmitter logic configured to:
provide the second electronic communication to the sender.

10. The system claim 9, wherein featurization includes performing at least one featurization operation that transforms at least a portion of the first information into one or more representations that describe characteristics of the at least a portion of the first information, the featurization logic being configured to perform the at least one featurization operation comprising one or more of:
a K-means clustering featurization;
a keyword featurization;
a content-based featurization;
a semantic-based featurization;
an n-gram featurization;
a skip-gram featurization;
a bag of words featurization;
a char-gram featurization; or
a feature selection featurization;
wherein the first electronic communication comprises one or more of:
an electronically mailed (emailed) support request;
a technical support request;
a posting on messaging thread or forum;
a social media posting;
an instant message;
a conversation with automated mechanism;
a billing request;
feedback; or
a notification;
or
wherein the measure of similarity is determined by a machine-learning comparison model.

11. The system of claim 9, wherein the second information comprises at least one of:
a previously-determined resolution,
one or more previously-received electronic communications, or
a selectable link to a proposed resolution, the selectable link being automatically generated based on a determination of the proposed resolution; and
wherein the responder logic is configured to provide portions of the second information in the second communication in an order according to the measure of similarity.

12. A method performed in a computing system, the method comprising:
receiving a first electronic communication from a sender;
performing at least one featurization operation for first information of the first electronic communication to generate a feature vector;
providing the feature vector as an input to a machine-learning model that automatically determines a model output based on the feature vector;
based at least on the model output, automatically selecting one or more of second information from a plurality of support information or a recipient from a plurality of possible recipients; and
performing at least one of:
generating a second electronic communication that includes the second information and providing the second electronic communication to at least one of:
the sender, or
the recipient; or
providing the first electronic communication to the recipient.

13. The method of claim 12, wherein the machine-learning model is a classifier, a regression model, a clustering model, or a comparison model.

14. The method of claim 12, wherein a featurization operation is an operation that transforms at least a portion of the first information into one or more representations that describe characteristics of the at least a portion of the first information, the at least one featurization operation including one or more of:
a K-means clustering featurization;
a keyword featurization;
a content-based featurization;
a semantic-based featurization;
an n-gram featurization;
a skip-gram featurization;
a bag of words featurization;
a char-gram featurization; or
a feature selection featurization;
or
wherein the first electronic communication comprises one or more of:
an electronically mailed (emailed) support request;
a technical support request;
a posting on messaging thread or forum;
a social media posting;
an instant message;
a conversation with automated mechanism;
a billing request;
feedback; or
a notification.

15. The method of claim 14, wherein the keyword featurization comprises a representation for one or more of keywords or keyphrases;
wherein the content-based featurization comprises at least one electronic message attribute of a character count, a byte count, or a ratio of numeric to alphabetic characters;
or
wherein the semantic-based featurization comprises one or more triplet sets that each include an entity, and action, and a qualifier.

16. The method of claim 12, wherein said generating the feature vector further comprises at least one of:
generating the feature vector also based on support reference information accessible through a network; or
generating the feature vector also based on a textual output of a character recognition operation performed for an attachment to the first electronic communication.

17. The method of claim 12, wherein the method further comprises determining one or more previously-received electronic communications associated with a previously-determined resolution based on a measure of similarity between the feature vector and feature vectors associated with the one or more previously-received electronic communications, and wherein the second information comprises at least one of:
a representation of the previously-determined resolution,
at least one of the one or more previously-received electronic communications, or
one or more previously-received and annotated electronic communications associated with the previously-determined resolution, where at least one answer string is annotated;
or
wherein the second information comprises a support reference portion comprising:
a step-by-step solution, or
a selectable link to a proposed resolution.

18. The method of claim 12, wherein the first electronic communication or the first information is related to a bug;
the method further comprising:
extracting one or more descriptions of actions taken by the sender from the first information according to a neural network model; and
automatically generating at least one test against the bug based on the extracted one or more descriptions of actions.

19. The method of claim 12, further comprising:
obtaining feedback associated with the second electronic communication that includes one or more of:
an efficacy rating for the second information from the sender,
a number of communications that have been exchanged between the sender and the recipient for a resolution,
a lack of a response from the sender to the second electronic communication,
an amount of time elapsed between the provision of the first electronic communication to the recipient and when the recipient takes an action in response to the first electronic communication, or
the feature vector and the model output; and
updating the machine-learning model as an incremental update or as a full update based on the feedback.

20. The method of claim 12, further comprising at least one of:
cleaning unstructured text in the first information prior to processing the first information according to the at least one featurization operation; or
determining the recipient further based on a prior electronic communication of the sender.
